(19) United States
(12) Patent Application Publication
(10) Pub. No.: US 2007/0252864 A1
(43) Pub. Date: Nov. 1, 2007

(54) Ink-Jet Recording Apparatus

(75) Inventor: Yuta Uchino, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/739,961

(22) Filed: Apr. 25, 2007

(30) Foreign Application Priority Data
Apr. 28, 2006 (JP) 2006-127010

(51) Int. Cl. B41J 2/165

(52) U.S. Cl. 347/29

(57) ABSTRACT

An ink-jet recording apparatus includes: a recording device which includes a nozzle surface and which records an image on a recording medium by ejecting droplets of ink from nozzles open in the nozzle surface while reciprocating in a predetermined direction; a maintenance unit which includes a nozzle cap coming into fluid-tight contact with the nozzle surface for covering the nozzles, a pump to be connected to the nozzle cap for sucking the ink from the nozzles, and a waste ink tank to which the ink sucked by the pump is discharged; a platform which supports the recording device and the maintenance unit at respective predetermined positions thereof; and an outer cover which is fitted on the platform. The maintenance unit further includes: a frame which holds the pump; a pump tube which is provided for the pump and connected to the waste ink tank and which is divided into a first tube and a second tube; and a first tube joint which is provided on the frame, which interconnects the first tube and the second tube, and which is disposed at a position in which the first tube joint is exposed from the platform in a state in which the outer cover is removed.

The present application is based on Japanese Patent Application No. 2006-127010 filed on Apr. 28, 2006, the contents of which are incorporated herein by reference.

### BACKGROUND OF THE INVENTION

1. Field of the Invention

The present invention relates to an ink-jet recording apparatus which performs recording of images, characters and the like on a recording medium by ejecting ink from an ink-jet recording head and, more particularly, to such an ink-jet recording apparatus including a purging mechanism for sucking and discharging ink from an inkjet recording bead by a sucking pump.

2. Description of the Related Art

There has conventionally been provided an image recording apparatus which performs recording of images, characters and the like by ejecting ink on a recording medium (generally, a recording sheet) based on input signals. As such an image recording apparatus, there has been known an ink-jet printer. The ink-jet printer is configured to introduce ink to an actuator of a recording head, and to eject the ink which is pressurized based on input signals by utilizing deflection or flexure of piezoelectric elements, electrostrictive elements, and so on, or by utilizing local or partial boiling of ink by heat-generating elements, so that the pressurized ink is ejected onto the recording sheet.

In the ink-jet printer, when a recording sheet is fed onto a sheet-discharge tray from a sheet-supply tray, a recording operation is performed such that ink is selectively ejected on the recording sheet from the recording head. During the recording operation, air bubbles may be generated in nozzles through which ink in the recording head is ejected, or the nozzles may be plugged or clogged with foreign substances, whereby an ink ejection failure may occur. Therefore, a so-called “purging operation” is performed in a conventional inkjet printer, for thereby preventing or restoring the ink ejection failure. The “purging operation” is for removing, by sucking, the air bubbles and/or the foreign substances from the nozzles of the recording head. A maintenance unit, which is arranged to perform the “purging operation” by a negative pressure, includes a cap for covering the nozzles of the recording head, a pump for sucking ink from the nozzles by depressurizing a space in the cap, a waste ink tank for trapping ink sucked by the pump, and a tube for connecting the pump to the waste ink tank.

Meanwhile, a length of the tube connecting the pump and the waste ink tank is determined, for instance, depending upon a relative position of the pump and the waste ink tank. Namely, recently, there has been a growing demand for reduction in the weight and size with respect to design of the ink-jet printer, whereby the waste ink tank is sometimes disposed at a position distant from the pump or a position above the pump. In these cases, the tube is arranged to be routed three-dimensionally in a casing of the ink-jet printer. In this case, if a single long tube is used, a work for arrangement of the tube becomes difficult. To solve this problem, JP-2002-301831A discloses an example of an ink-jet printer wherein a tube is divided, and JP-2004-130706A discloses an example of an ink-jet printer wherein divided tubes are connected by a joint. Because the tube is divided, a length of each of the tubes routed in a work for arrangement of the tubes becomes shorter, thereby facilitating the work for arrangement of the tubes.

In the ink-jet printer, the recording head, the pump, and the waste ink tank need to be subjected to a maintenance operation in which tubes must be removed. End portion of each of the tubes, that is, connecting portion of the each tube connected to the pump, the waste ink tank, or the joint is diametrically expanded to have an expanded inner diameter, when being fitted on the joint or the like. The expanded inner diameter is not restored to its original diameter when the connecting portion is removed from the joint or the like. Therefore, when the tube is fitted again on the pump or the like, after having been removed from the pump, leakage of air bubbles and/or ink occurs, requiring replacement of the tube with a new one. Thus, the removed tube is not reused.

However, in this case, the tube is replaced with a new one every time the pump or the like is subjected to the maintenance work, thereby causing a problem that a total cost of the maintenance rises. To solve this problem, a length of the tube may be determined in advance to have an extra length, so as to allow the diametrically expanded end portion to be cut from the tube in the maintenance of the pump or the like, and to enable the tube to be reused for its fitting on the pump or the like. However, because the length of the tube is determined depending upon a relative position of the pump and the waste ink tank, there is an upper limit of the length of the tube. Therefore, in a second maintenance, the tube needs to be replaced with a new one. As a result, there is no effective means for reducing the total cost of the maintenance.

In addition, where the tube is divided, the arrangement work of the tube is easy, but if the joint is not disposed at a position for a user to easily work, the maintenance work becomes difficult. In some cases, the components such as the pump and the waste ink tank must be removed for allowing the tube to be fitted on and removed from the joint. In this case, the maintenance work becomes complicated, and there is a risk that the total cost of the maintenance including its working cost rises considerably.

### SUMMARY OF THE INVENTION

This invention has been developed in view of the above-described situations, and it is an object of the present invention to provide an ink-jet recording apparatus in which a maintenance work can be easily and inexpensively performed on a maintenance unit.

The object indicated above may be achieved according to an aspect of the present invention, which provides an ink-jet recording apparatus comprising: a recording device which includes a nozzle surface and which records an image on a recording medium by ejecting droplets of ink from nozzles open in the nozzle surface while reciprocating in a predetermined direction; a maintenance unit which includes a nozzle cap coming into fluid-tight contact with the nozzle surface for covering the nozzles, a pump to be connected to the nozzle cap for sucking the ink from the nozzles, and a waste ink tank to which the ink sucked by the pump is discharged; a platform which supports the recording device and the maintenance unit at respective predetermined positions thereof; and an outer cover which is fitted on the platform, wherein the maintenance unit further includes: a frame which holds the pump; a pump tube which is provided for the pump and connected to the waste ink tank and which is divided into a first tube and a second tube; and a first tube joint which is provided on the frame, which interconnects the first tube and the second tube, and which is disposed at a position in which the first tube joint is exposed from the platform in a state in which the outer cover is removed.

In the ink-jet recording apparatus constructed as described above, the pump tube is divided and interconnected by the first tube joint provided on the unit frame of the maintenance unit. The first tube joint is disposed at a position in which the first tube joint is exposed from the platform, whereby the tube joint is exposed when the outer cover is removed, that is, the tube joint is not hidden behind the platform in a state in which a user opposes to the first tube joint, more specifically, the tube joint is directly and visually identified by a user. Therefore, a user can fit or remove the pump tube on or from the tube joint with ease by only removing the outer panel. In addition, because the pump tube is divided, there is no need to replace an entire pump tube in replacement of the pump tube.

### BRIEF DESCRIPTION OF THE DRAWINGS

The above and other objects, features, advantages and technical and industrial significance of the present invention will be better understood by reading the following detailed description of preferred embodiments of the invention, when considered in connection with the accompanying drawings, in which:

FIG. 1 is a perspective view of a multi function device (hereinafter, referred to as “MFD”) to which the present invention is applied;

FIG. 2 is a perspective view of the MFD showing a state in which a document cover is open;

FIG. 3 is a perspective view of the MFD showing a state in which the flatbed scanner unit is open;

FIG. 4 is an exploded perspective view of main portion of the MFD;

FIG. 5 is an exploded perspective view of the main portion of the MFD;

FIG. 6 is an enlarged perspective view of main portion of the MFD shown in FIG. 5;

FIG. 7 is a perspective view of main portion of the MFD;

FIG. 8 is a side elevational view showing an internal structure of the MFD in cross section;

FIG. 9 is a partial plan view showing an internal structure of the printer unit of the MFD;

FIG. 10 is a bottom view of a recording head of the printer unit;

FIG. 11 is an enlarged view partially in cross section showing an internal structure of the recording head;

FIG. 12 is a perspective view showing a maintenance unit of the printer unit;

FIG. 13 is a plan view showing a structure of a purging mechanism included in the maintenance unit;

FIG. 14 is a cross-sectional view taken along line 14-14 of FIG. 13;

FIG. 15 is a cross-sectional view showing a state in which a cap and an air exhaust cap of the purging mechanism of the printer unit are lifted;

FIG. 16 is an enlarged perspective view of one of tube joints included in the maintenance unit;

FIG. 17 is an enlarged perspective view of the other of the tube joints included in the maintenance unit;

FIG. 18 is a perspective view of the maintenance unit showing an external view of a port changing mechanism;

FIG. 19 is a perspective view of a waste ink tank included in the maintenance unit; and

FIG. 20 is a cross-sectional view of the waste ink tank included in the maintenance unit.

### DESCRIPTION OF THE PREFERRED EMBODIMENTS

Hereinafter, there will be described preferred embodiments of the present invention by reference to the drawings. It is to be understood that the following embodiments are described only by way of example, and the invention may be otherwise embodied with various modifications without departing from the scope and spirit of the invention.

### Entire Constitution

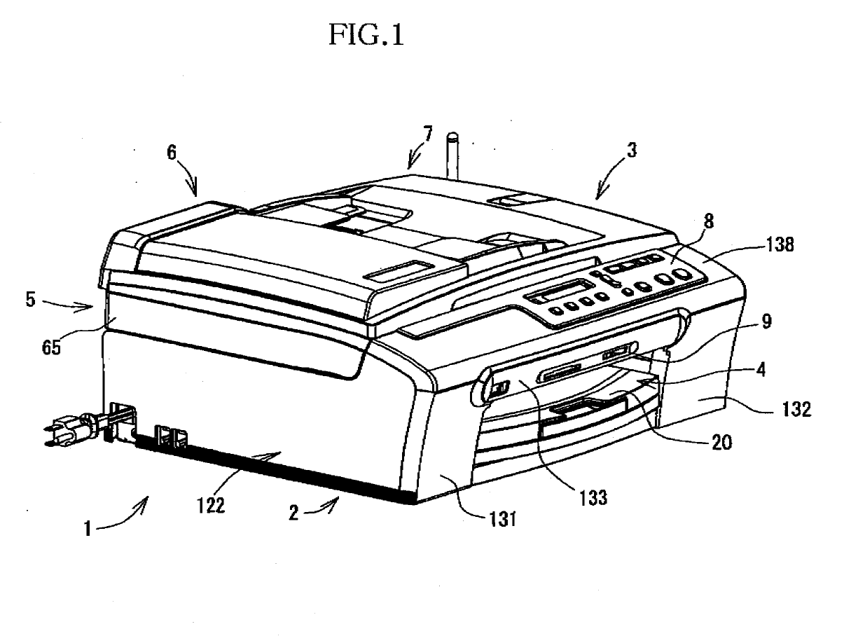

FIG. 1 is a perspective view of a multi function device 1 (hereinafter, referred to as a “MFD 1”) to which the present invention is applied.

The MFD 1 (an ink-jet recording apparatus) includes a printer unit 2 in its lower part and a flatbed scanner unit 3 in its upper part. The printer unit 2 and the flatbed scanner unit 3 (hereinafter, referred to as “FBS unit 3”) are configured to realize a printer function, a scanner function, a copier function, and a facsimile function, In the MFD 1, the printer unit 2 corresponds to the ink-jet recording apparatus to which the present invention is applied. Accordingly, the functions other than the printer function may be omitted, that is, the ink-jet recording apparatus may be configured, for example, as a single-function printer from which the FBS unit 3 is omitted and which does not have the scanner, copier, or facsimile functions.

In the printer function, the MFD 1 is mainly connected to an external computer (not shown), so that the printer unit 2 records, based on image data or text data transmitted from the computer, an image or a text on a recording medium such as a recording sheet. In addition, the MFD 1 is connected to an external device such as a digital camera, so that the printer unit 2 records, based on image data outputted from the external device, an image on a recording sheet. Moreover, the printer unit 2 records, based on image data stored in the each of various sorts of recording media such as a memory card, an image on a recording sheet.

In the scanner function, image data of the document read by the FBS unit 3 is transmitted to the computer. Alternatively, the image data can be recorded in any of various sorts of recording media such as a memory card. In the copier function, the printer unit 2 records an image on a recording sheet, based on image data read by the FBS unit 3. In the facsimile function, image data read by the FBS unit 3 is transmitted by facsimile via a telephone line. In addition, based on facsimile data received by the MFD 1, the printer unit 2 records an image on a recording sheet.

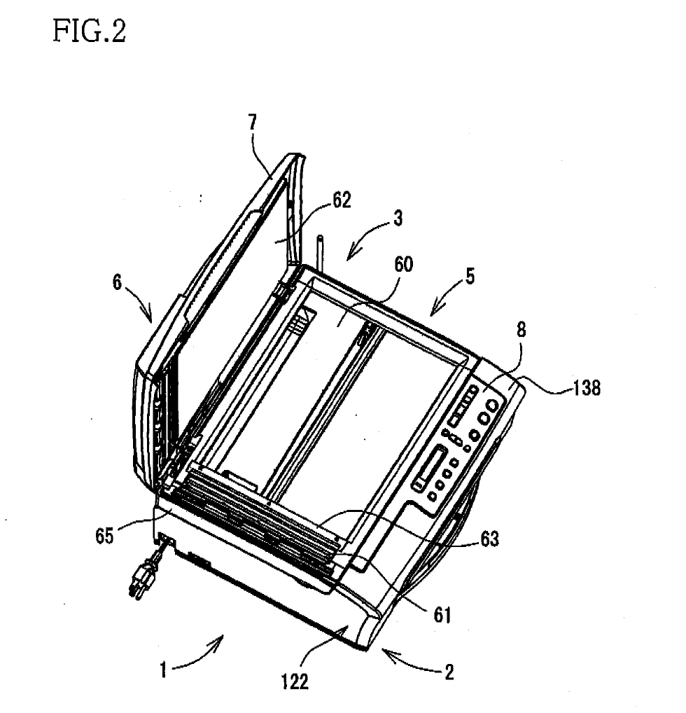

FIG. 2 is a perspective view of the MFD 1 in a state in which a document cover 7 is opened to expose a document placing board 5.

As shown in FIGS. 1 and 2, the PBS unit 3 includes the document placing board 5 serving as a Flatbed Scanner (FBS) and the document cover 7 provided on the document placing board 5. The document cover 7 is attached to the document placing board 5 via hinges (not shown) so as to pivot about one of end portions thereof relative to the document placing board 5. In the following description, the side of the MFD 1 about which the document cover 7 pivots will be referred to as a “rear side portion” or “rear portion” of the MFD 1. In this connection, the other side portions of the MFD 1 will be referred to as a “front side portion,” a “right side portion,” and a “left side portion” of the MFD 1, respectively. The document cover 7 is provided with an Auto Document Feeder 6 (hereinafter, referred to as “ADF 6”) which is opened and closed together with the document cover 7. It is noted that the ADF 6 may be omitted.

As shown in FIG. 2, platen glasses 60, 61 are provided on an upper face of the document placing board 5. When the document cover 7 is closed to cover the document placing board 5, the platen glasses 60, 61 are covered by the document cover 7 (as shown in FIG. 1). On a lower surface of the document cover 7, there is provided a pressing member 62 for pressing a document placed on the platen glass 60. The platen glass 60 defines a document reading areas in the case where the FBS unit 3 functions as the FBS. The platen glass 61 defines a document reading area in the case where the ADF 6 of the FBS unit 3 is used. The platen glasses 60, 61 are transparent glass plates or acrylic plates, for instance. Therefore, an interior of a casing 65 corresponding to the document reading areas is visually recognized through the platen glasses 60, 61.

A positioning member 63 is provided between the platen glasses 60, 61. When a document is placed on the platen glass 60, the positioning member 63 serves as a reference for positioning the document. An upper surface of the positioning member 63 is marked with markings for indicating positions corresponding to various sizes of documents such as A4 and B5 documents. When the ADF 6 is used, the positioning member 63 functions as a guide member for guiding a document conveyed on the platen glass 61.

As shown in FIGS. 1 and 2, an operation panel 8 is provided in a front face of the MFD 1. The operation panel 8 includes various operation buttons and a liquid crystal display (LCD), and the MFD 1 is operated according to commands from the operation panel 8. In addition, in the case where the MFD 1 is connected to an external computer, the MFD 1 is operated according to commands transmitted from the computer via a printer driver or a scanner driver.

A slot portion 9 is provided in a left, top portion of the front face of the MFD 1. The slot portion 9 is configured such that various sorts of small-size memory cards each as a recording medium are mounted therein. When any one of the small size memory cards is mounted in the slot portion 9, image data stored in the memory card is read and information related to the read image data is displayed on the LCD. When the operation panel 8 is operated, one or more desired images displayed on the LCD can be recorded on the recording sheet(s).

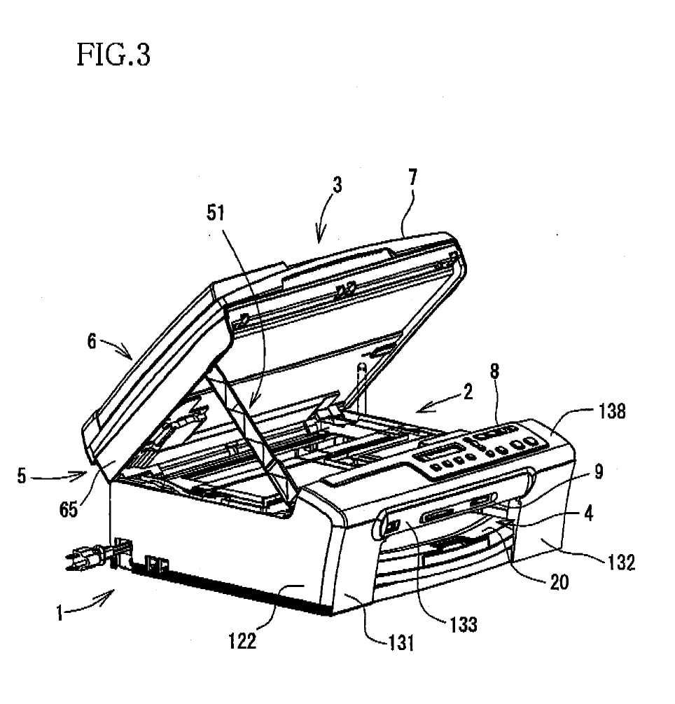

FIG. 3 is a perspective view showing a state in which the FBS unit 2 is opened to expose the printer unit 2.

As shown in FIG. 3, the casing 65 of the document placing board 5 is supported by the printer unit 2 so as to pivot about a rear portion thereof as a pivoting axis. The document placing board 5 is opened such that a front end thereof, as a free end, moves upward relative to the printer unit 2. The operation panel 8 is fixed to the printer unit 2 so that the operation panel 8 is not opened and closed together with the document placing board 5. When the FBS unit 3 is opened in this manner, an interior of the printer unit 2 is exposed, whereby various sorts of maintenance works can be easily performed.

A stopper 51 having an elongate plate-like shape is provided between the printer unit 2 and the PBS unit 3. The stopper 51 extends in a rearward direction and has a length which is slightly shorter than a depth of the MFED 1. A proximal end of the stopper 51 is pivotably connected to an upper portion of the printer unit 2 near the front side of the MFD 1. A distal end of the stopper 51 near the rear side of the MFD 1 serves as a pivoting end and is slidably connected to the casing 65. Accordingly, as shown in FIG. 3, when the FBS unit 2 is opened to expose the printer unit 2, the FBS unit 3 is diagonally supported by the stopper 51.

As shown in FIGS. 1 and 3, an opening 4 is formed in the front face of the MFD 1. Through the opening 4, a sheet-supply tray 20 and a sheet-discharge tray 21 are attached in the MFD 1. It is noted that the sheet-discharge tray 21 which is located on a back of the opening 4 is not shown in these figures.

### Casing and Exterior

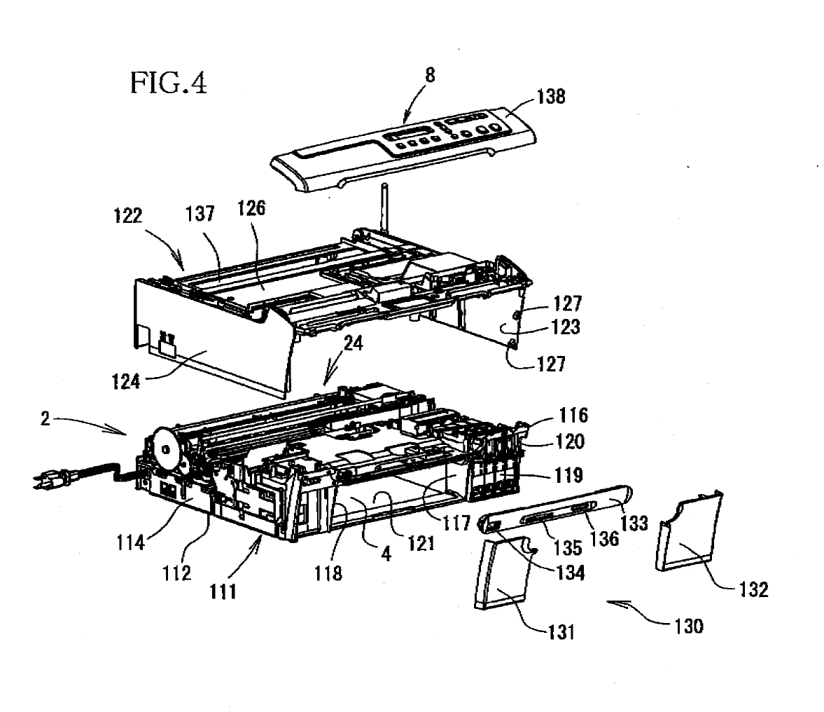

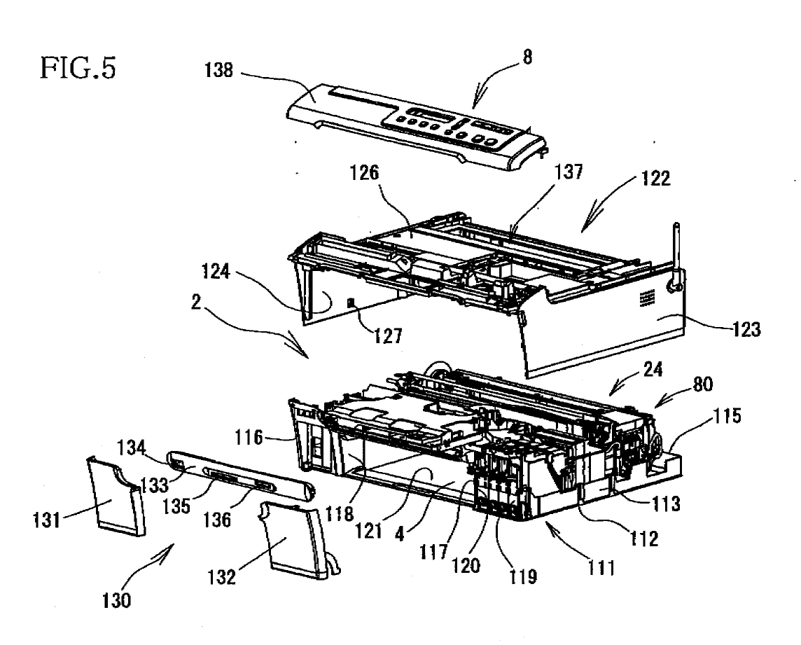

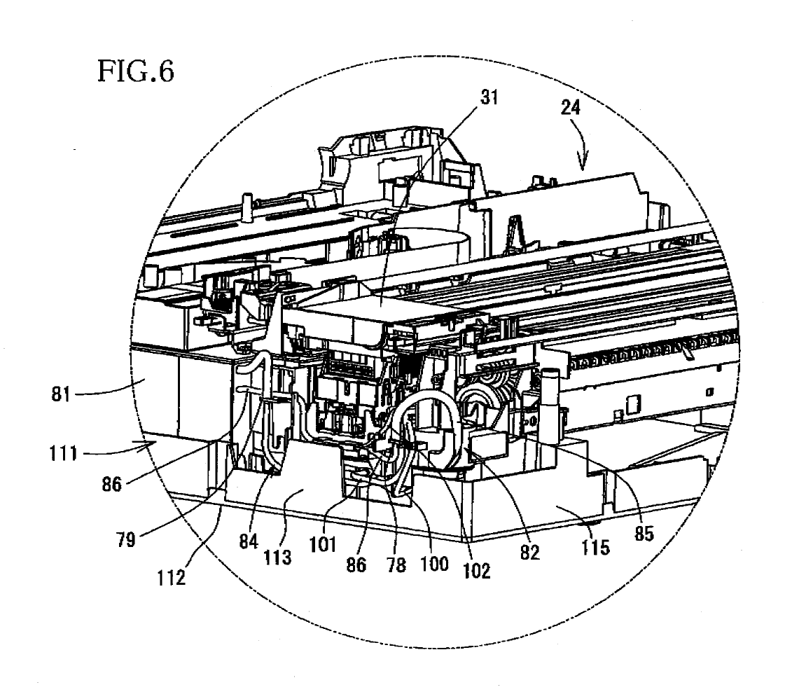

FIGS. 4 and 5 are exploded perspective views of main portion of the MFD 1. FIG. 4 is the perspective view of the MFD 1 as seen from a front left side and FIG. 5 is the perspective view of the MFD 1 as seen from a front right side. FIG. 6 is an enlarged perspective view of main portion of FIG. 5.

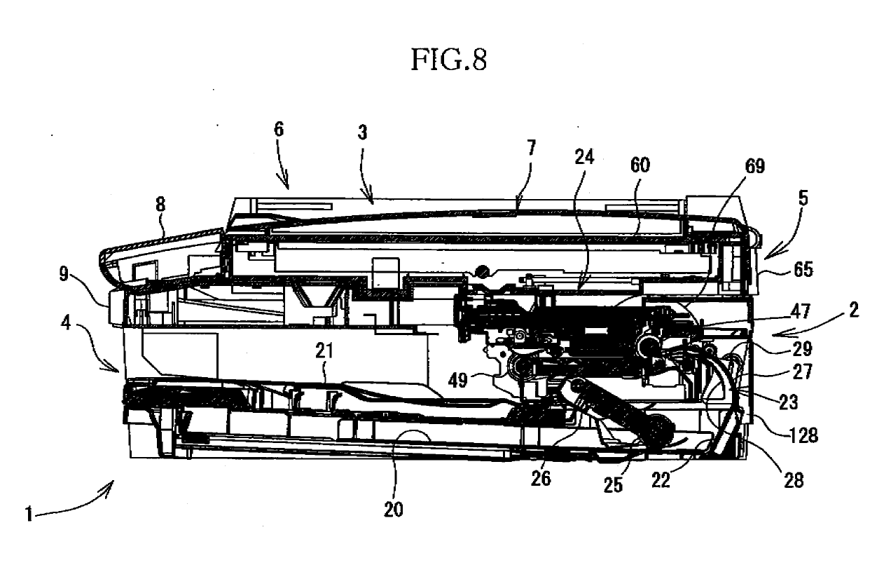

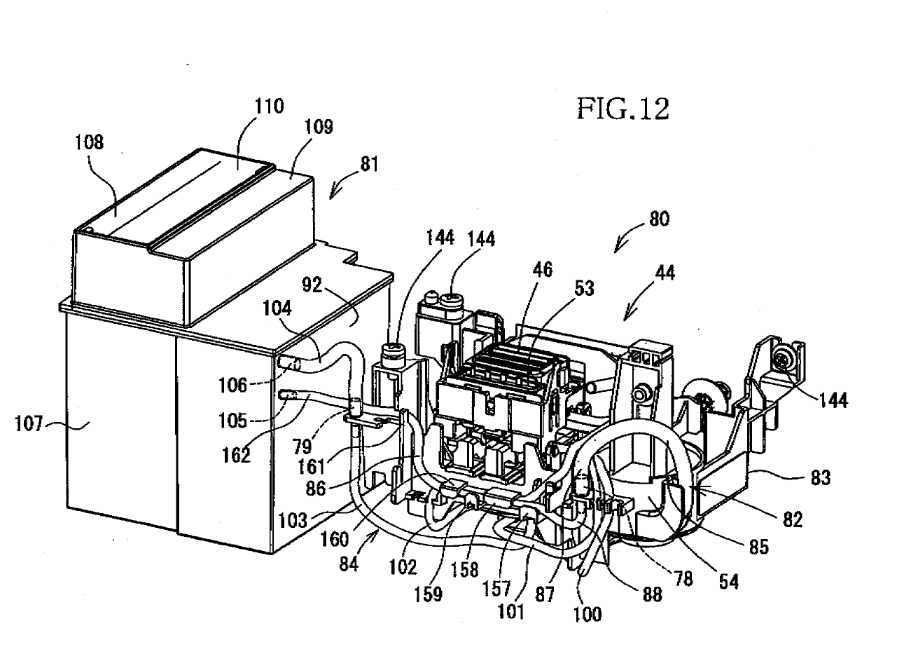

These figures show the MFD 1, with the FBS unit 3 removed. The printer unit 2 has a platform 111 on which there are mounted an image recording portion 24 (recording device), other functional components for image recording, a maintenance unit 80 (as shown in FIG. 12) having a purging mechanism 44, a sheet-feed roller 47, a sheet-discharge roller 49, and other driving components (as shown in FIG. 8) for feeding a recording sheet which will be described below. A mutual positional relationship among the functional components and the driving components is particularly important to realize clear image recording. Accordingly, the recording portion 24, the maintenance unit 80, the sheet-feed roller 47, the sheet-discharge roller 49, and other components are positioned and fixed to the platform 111 at their respective predetermined positions.

The platform 111 is shaped like a tray as a whole. The platform 111 includes a bottom plate portion 112 which constitutes a bottom face of the platform 111, ribs 113, 114 formed on right and left end portions of the bottom plate portion 112, rib 115 formed on a rear end portion of the bottom plate portion 112, and a base 116 formed on a front end portion of the bottom plate portion 112, that is, formed in a portion of the platform 111 corresponding to the front surface of the MFD 1. The base 116 has a rectangular frame-like shape. On the base 116, ribs 117, 118 by which the base 116 is divided into three parts (as shown in FIG. 5) are formed. A central portion of the base 116 defined by the ribs 117, 118 constitutes the opening 4 (FIG. 1). In a portion of the base 116 which is located on a right side of the rib 117, a refill unit holding portion 120 in which a refill unit 119 is accommodated and held is provided. The platform 111 may be formed of a steel plate but may also be formed of synthetic resin integrally with the base 116. Alternatively, only the base 116 may be formed of synthetic resin and attached to the platform 111.

The bottom plate portion 112 is constituted by a flat plate. In the present embodiment, an opening 121 is formed in the bottom plate portion 112 by cutting away a central portion thereof for a reduction in the weight of the platform 111. However, the opening 121 may be omitted. As shown in FIG. 4, the rib 114 is continuously formed on a left end portion of the bottom plate portion 112. In the present embodiment, the rib 114 extends upwardly perpendicular to the left end portion of the bottom plate 112. The rib 114 has an inverted-U-shaped cross section, thereby ensuring a sufficient stiffness of the rib 114. The rib 114 may be formed of a flat plate, not having the inverted-U-shape cross section, extending upwardly and perpendicularly to the left end portion of the bottom plate portion 112 and may also be formed from an elongate member which is different from a member of the bottom plate portion 112 and which is provided so as to protrude from the left end portion of the bottom plate portion 112. A height dimension of the rib 114 is about 25-75 mm, thereby ensuring a sufficient stiffness of the bottom plate portion 112. Further, openings or cutouts are formed, as needed, in the rib 114 for convenience of wiring or the like.

As shown in FIG. 5, the rib 113 is continuously formed on a right end portion of the bottom plate portion 112. In the present embodiment, the rib 113 extends upwardly perpendicular to the right end portion of the bottom plate 112. The rib 113 may have the inverted-U-shaped cross section as well as the rib 114, thereby enhancing a stiffness of the rib 113, In addition, similar to a case of the rib 114, the rib 113 may be formed from the elongate member provided so as to protrude from the right end portion of the bottom plate portion 112. A height dimension of the rib 113 is about 12-50 mm, thereby ensuring a sufficient stiffness of the bottom plate portion 112. Further, openings or cutouts are formed, as needed, in the rib 113 for convenience of wiring or maintenance of the maintenance unit 80 described below in detail.

Furthermore, the rib 115 is continuously formed on a rear end portion of the bottom plate portion 112. In the present embodiment, the rib 115 extends upwardly perpendicular to the rear end portion of the bottom plate portion 112. The rib 115 may have the inverted-U-shaped cross section as well as the rib 114, thereby enhancing a stiffness of the rib 115. In addition, similar to the case of the rib 114, the rib 115 may be formed from the elongate member provided so as to protrude from the rear end portion of the bottom plate portion 112. A height dimension of the rib 115 is about 12-50 mm, thereby ensuring a sufficient stiffness of the bottom plate portion 112. As well as the rib 114, openings or cutouts are formed, as needed, in the rib 115 for convenience of wiring or the like. Further, the ribs 113-115 are formed for ensuring the stiffness of the bottom plate portion 112, but the platform 111 may be formed so as to have a plate-like shape as a whole, with the ribs 113-115 omitted, as long as the bottom plate portion 112 has enough stiffness to properly position and fix the recording portion 24 and the like.

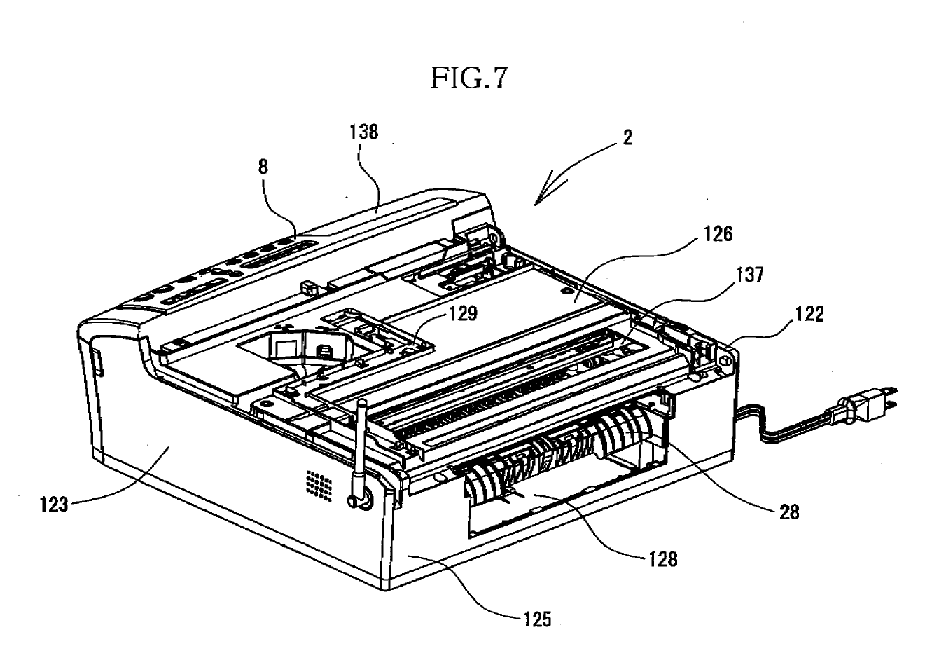

FIG. 7 is a perspective view of main portion of the MFD 1 as seen from a rear side. FIG. 7 shows the MFD 1, with the FBS unit 3 removed.

As shown in FIGS. 4 and 7, the printer unit 2 includes an outer panel (outer cover) 122. The outer panel 122 has a right wall 123, a left wall 124, and a rear wall 125. Namely, the outer panel 122 is formed so as to have a frame shape having right, left, and rear walls and not having a front wall. Further, a partition wall portion 126 is provided and continuous with upper end portions of the right, left, and rear walls 123, 124, and 125. The partition wall portion 126 serves as a partition between the FBS unit 3 and the recording portion 24. Namely, the recording portion 24 is covered by the partition wall portion 126. On the partition wall portion 126, there is formed a wire guide 129 (as shown in FIG. 7) along which cables are arranged for communication of control signals among the recording portion 24 and the like. In the partition wall 126, there is formed an opening 137, as needed, through which a maintenance of the recording portion 24 and the like can be performed. However, the partition wall portion 126 may be omitted.

As shown in FIGS. 4 and 5, the outer panel 122 is put on the printer unit 2 from above. A plurality of engaging claws 127 are projectedly provided on the right and left walls 123, 124 of the outer panel 122. The engaging claws 127 are formed so as to be engaged with the platform 111, thereby permitting the outer panel 122 to be fixed to the platform 111. The printer unit 2 is covered by the outer panel 122 fixed to the platform 111, so that the right and left walls 123, 124 constitute right and left side face of the MFD 1, respectively, and so that the rear wall 125 constitutes a rear face of the MFD 1. As shown in FIG. 7, an opening 128 is formed in a central portion of the rear wall 125 for facilitating maintenance or recovery from a trouble such as a paper jam.

As shown in FIGS. 4 and 5, a front panel 130 is attached to the outer panel 122. The front panel 130 includes a decoration plate 131, a refill unit cover 132, and a slot cover 133. The front panel 130 is formed of synthetic resin but may be constituted by a metal plate. The decoration plate 131 is attached to a left end of the outer panel 122 and covers a portion of the base 116 of the platform 111 which is located on a left side of the rib 118. The refill unit cover 132 is attached to a right end of the outer panel 122. The refill unit cover 132 is attached to the outer panel 122 such that the refill unit cover 132 is opened and closed to expose and cover the outer panel 122. Therefore, when the refill unit cover 132 is closed, a portion of the base 116 which is located on the right side of the rib 117 is covered, that is, as shown in FIG. 1, the refill unit 119 is covered by the refill unit cover 132. When the refill unit cover 182 is opened, the refill unit 119 is exposed, thereby facilitating a replacement of ink tanks provided in the refill unit 119. The slot cover 133 is an outer plate member of the slot portion 9 and functions as a decoration plate. Accordingly, positions of the slot portion 9 in which small size memory cards are to be mounted are emphasized by the slot cover 133. Openings 134-186 are formed in the slot cover 133. Shapes of the openings 134-136 correspond to shapes of various types of the small size memory cards to be mounted in the slot portion 9.

As shown in FIGS. 4 and 7, the operation panel 8 includes a decoration plate 138 which is formed of resin or metal. The decoration panel 138 is attached to a front upper end of the outer panel 122. The various operation buttons and the liquid crystal display (LCD) are assembled with the decoration plate 138.

### Printer Unit

FIG. 8 is a side elevational view showing an internal structure of the MFD 1 in cross section.

As shown in FIG. 1, the opening 4 is formed in the front face of the MFD 1 as described above and the sheet-supply tray 20 and a sheet-discharge tray 21 are mounted in the MFD 1 through the opening 4. In the sheet-supply tray 20, desired sizes of recording sheets, such as A4 and B5 sheets, are accommodated. The sheet-discharge tray 21 is supported by the sheet supply tray 20 and disposed thereon. The sheet-supply tray 20 and the sheet-discharge tray 21 are superposed on each other in a vertical direction and mounted in the MFD 1.

In a back portion of the sheet-supply tray 20 mounted in the MFD 1, an inclined sheet-separate plate 22 is disposed. The inclined sheet-separate plate 22 separates recording sheets fed from the sheet-supply tray 20 and guides the separated sheet upward. A sheet-feed path 23 is formed above the inclined sheet-separate plate 22, The sheet-feed path 23 extends from the sheet-supply tray 20 so as to extend in a direction away from the front side toward the rear side of the MFD 1, curves upward from a portion above the inclined sheet-separate plate 22, and extends in a direction away from the rear side toward the front side of the MFD 1. Then, the sheet-feed path 23 passes through below the recording portion 24 and reaches the sheet-discharge tray 21. The recording sheet is fed from the sheet-supply tray 20 to the recording portion 24 while being guided by the sheet-feed path 23 such that the recording sheet makes an upward U-turn in which a direction of feeding of the recording sheet is changed from the rearward direction to a frontward direction, and finally reaches the recording portion 24. After the recording sheet is subjected to a recording operation at the recording portion 24, the recording sheet is discharged onto the sheet-discharge tray 21.

There is disposed, above the sheet-supply tray 20, a sheet-supply roller 25 for separating the recording sheets stacked on the sheet-supply tray 20 one by one and supplying the separated sheet toward the sheet-feed path 23. The sheet-supply roller 25 is supported at a lower end portion of a sheet-supply arm 26 which is pivotable downward and upward so as to move toward and away from the sheet-supply tray 20. The sheet-supply roller 25 is rotated by a drive force of a motor (not shown).

The sheet-supply arm 26 is pivotable about its proximal end, as a pivoting end, such that the lower end portion thereof moves upward and downward. When the sheet-supply tray 20 is mounted in the MFD 1, the sheet-supply arm 26 is pivotably moved downward such that the sheet-supply roller 25 is brought into pressing contact with the sheet-supply tray 20. When the sheet-supply tray 20 is removed from the MFD 1, the sheet-supply arm 26 is lifted upward by a guide formed on a sheet-supply tray 20. When the sheet-supply arm 26 is pivotably moved downward, the sheet-supply roller 25 supported at the lower end portion of the sheet-supply arm 26 is brought into pressing contact with the recording sheets stacked on the sheet-supply tray 20. In this state, the sheet-supply roller 25 rotates, whereby an uppermost one of the recording sheets on the sheet-supply tray 20 is fed toward the inclined sheet-separate plate 22 owing to a friction force generated between a roller surface of the sheet-supply roller 25 and the recording sheet. The uppermost recording sheet fed toward the inclined sheet-separate plate 22 abuts at its front end onto the same 22 and is guided upward so as to be fed into the sheet-feed path 23. When the uppermost sheet is fed by the sheet-supply roller 25, the sheet immediately below the upper most sheet may be fed together with the uppermost sheet by friction or static electricity. However, the sheet in question is prevented from being fed by its abutting contact with the inclined sheet-separate plate 22.

The sheet-feed path 28 is defined by an outer guide surface and an inner guide surface facing each other with a predetermined distance therebetween, except a portion thereof in which the image recording portion 24 is disposed. For instance, a rear end portion of the sheet-feed path 23 is defined by an outer guide member 27 and an inner guide member 28 which are fixed to the frame. The outer guide member 27 is removably provided and configured so as to be removed through the opening 128 (FIG. 7) formed in the rear wall 125 of the outer panel 122. Guide rollers 29 are provided at predetermined portions of the sheet-feed path 23 particularly where the sheet-feed path 23 is curved. Roller surfaces of the guide rollers 29 are exposed at the outer guide surface. The guide rollers 29 are supported by the outer guide member 27 and rotatable about its axis that extends in a width direction of the sheet-feed path 23. The guide rollers 29 assure smooth feeding of the recording sheet contacting the outer guide surface at the portions of the sheet-feed path 23 where the path 23 is curved.

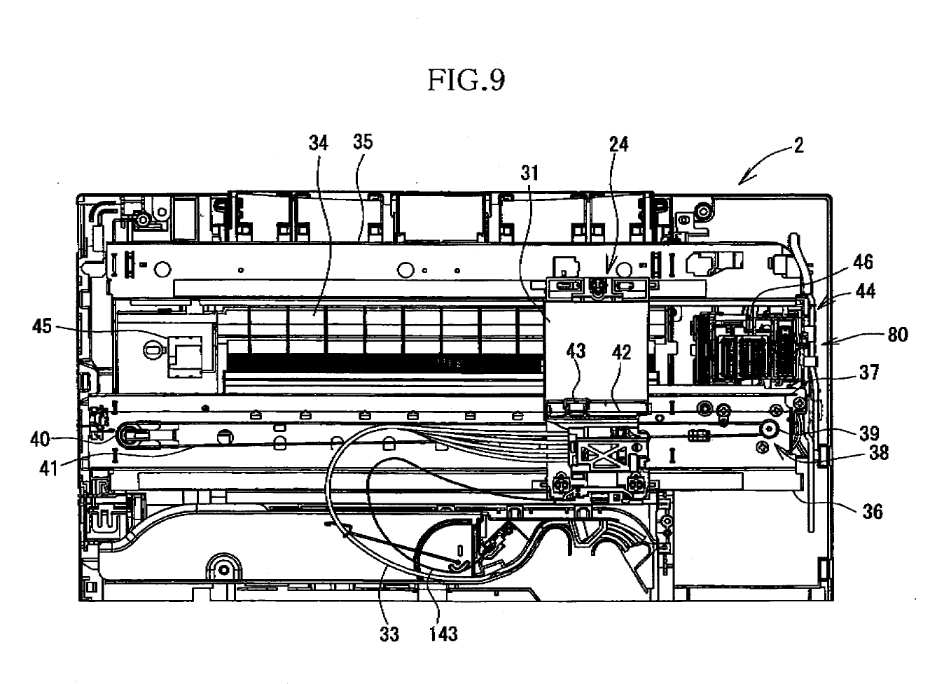

FIG. 9 is a partial plan view showing an internal structure of the printer unit 2.

The recording portion 24 includes a head carriage 31 on which a recording head 30 is mounted and which reciprocates in a main scanning direction perpendicular to a sheet feeding direction in which the recording sheets are fed. A cyan ink (C), a magenta ink (M), a yellow ink (Y), and a black ink (Bk) which are stored in ink tanks are supplied to the recording head 30 via respective ink tubes 33. The ink tanks are incorporated in the refill unit 119 (in FIGS. 4 and 5). The recording head 30 (not shown in FIG. 9) is exposed in a lower surface of the carriage 31 and ejects fine droplets of inks of respective colors from nozzles formed in the recording head 30. Owing to the reciprocation of the head carriage 31, the recording head 30 moves above a recording sheet being conveyed on a platen 34, so that the image is recorded on the recording sheet.

As shown in FIG. 9, a pair of guide rails 35, 36 are disposed above the platen 34. The guide rails 35, 36 are opposed and distant from each other in the sheet feeding direction. The guide rails 35, 36 extend in the width direction of the sheet-feed path 23. The head carriage 31 is mounted on the guide rails 35, 36 such that the head carriage 31 bridges the guide rails 35, 36. The head carriage 31 is slidably provided on the guide rails 35, 36, thereby enabling the reciprocating movement of the head carriage 31 described above.

The guide rail 35 is disposed on an upstream side of the guide rail 36 as viewed in the sheet feeding direction. The guide rail 35 is a flat plate-like member. A length of the guide rail 35 in the width direction of the sheet-feed path 23 is larger than a length of a range in which the head carriage 31 reciprocates. One of opposite ends of the head carriage 31 is slidably supported by an upper face of the guide rail 35. The guide rail 36 is disposed on a downstream side of the guide rail 35 as viewed in the sheet feeding direction. The guide rail 36 is a flat plate-like member as well as the guide rail 35. A length of the guide rail 36 (as measured in the width direction of the sheet-feed path 23) is about the same as that of the guide rail 35. The other of opposite ends of the head carriage 31 is sidably supported by an upper surface of the guide rail 36.

The guide rail 36 has an end portion 37 which is provided by its upstream end portion (as viewed in the sheet feeding direction) and which is bent upwardly and perpendicularly to a direction in which the guide rail 36 extends. The head carriage 31 has a pair of rollers (not shown) by which the end portion 37 of the guide rail 36 is nipped. As a result, the head carriage 31 is slidably supported on the guide rails 35, 36 and reciprocates in the width direction of the sheet-feed path 23 along the end portion 37. Further, the guide rails 35, 36 serve as a part of a frame which positions the sheet-feed roller 47, the sheet-discharge roller 49, and other driving components described below.

A belt driving mechanism 38 is provided on the upper surface of the guide rail 36. The belt driving mechanism 38 includes a driving pulley 39, a driven pulley 40, and a timing belt 41 which is wound around the driving pulley 39 and the driven pulley 40. The driving pulley 39 and the driven pulley 40 are provided near widthwise opposite ends of the sheet-feed path 23, respectively. The timing belt 41 has an endless loop-like shape with teeth formed in its inner surface. A shaft of the driving pulley 39 is supplied with a driving power from the motor (not shown). The timing belt 41 is circulated by a rotation of the driving pulley 39.

The head carriage 31 is fixed to the timing belt 41. The head carriage 31 reciprocates on the guide rails 35, 36 along the end portion 37 by the circulation of the timing belt 41. The recording head 30 mounted on the head carriage 31 reciprocates together with the head carriage 31 in the width direction of the sheet-feed path 23 as the main scanning direction. An encoder strip 42 of a linear encoder is provided above the guide rail 36 along the end portion 37. The linear encoder detects marks of the encoder strip 42 by a photo interrupter 43 provided on the head carriage 31. Based on a detection signal of the linear encoder, the reciprocating movement of the head carriage 31 is controlled.

As shown in FIGS. 8 and 9, the platen 34 is disposed so as to be opposed to the head carriage 31 in the vertical direction. The platen 34 extends over an intermediate portion in a range of the reciprocating movement of the head carriage 31 where each recording sheet passes. A length of the platen 34 in the main scanning direction is sufficiently greater than a width of a recording sheet of a maximum size that can be used in the MFD 1, so that widthwise opposite ends of each recording sheet pass on the platen 42.

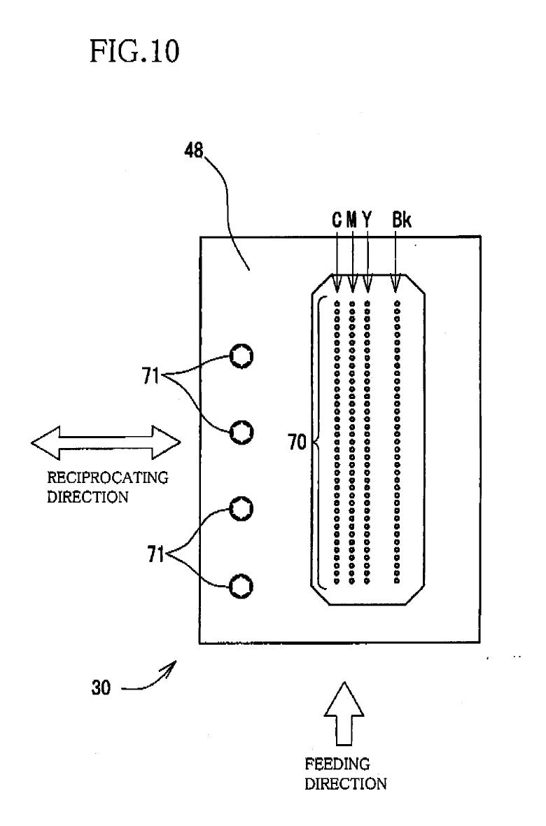

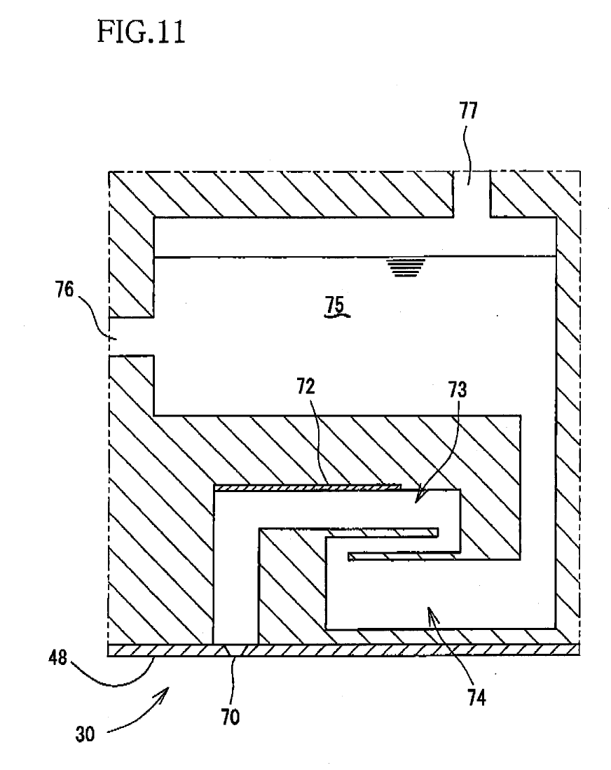

FIG. 10 is a bottom view of the recording head 30 of the recording portion 24. FIG. 11 is an enlarged view partially in cross section showing an internal structure of the recording head 30.

As shown in FIG. 10, the recording head 30 includes a plurality of nozzles 70 which are formed in a lower surface of the recording head 30, that is, in a nozzle surface 48. The nozzles 70 are formed, respectively corresponding to the inks of four colors, namely, cyan (C), magenta (M), yellow (Y), and black (Bk). In FIG. 10, a direction from bottom to top corresponds to the sheet feeding direction, while a right and left direction corresponds to a direction in which the head carriage 31 reciprocates (hereinafter, referred to as a “head-reciprocating direction”). The nozzles 70 corresponding to the four inks, CMYBk, are arranged in respective rows in the sheet feeding direction and the rows of the nozzles 70 are arranged in the head-reciprocating direction. A number of the nozzles 70 and a pitch of the same 70 in the sheet feeding direction are suitably determined depending upon, e.g., a resolution of images to be recorded. Further, a number of the rows of the nozzles 70 may be increased and decreased in accordance with a number of the inks to be used.

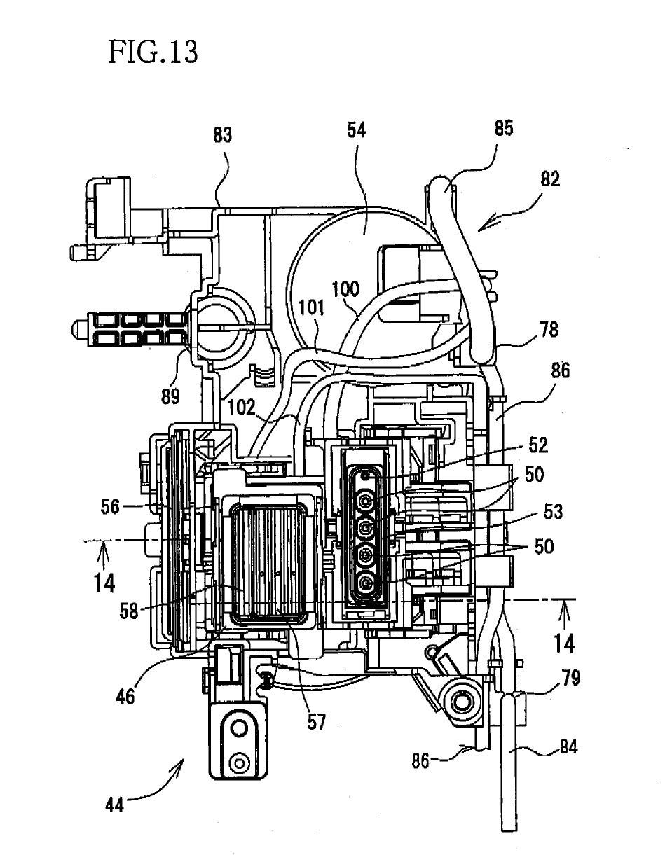

Air outlets 71 are formed in a side of the nozzles 70. In the present embodiment, four air outlets 71 are formed and respectively correspond to the four inks, CMYBk. For each air outlet 71, a check valve (not shown in FIG. 10) is provided in a passage which includes the air outlet 71. When the check valve is opened by a push rod 50 (as shown in FIG. 13) of the purging mechanism 44, the air outlet 71 is opened.

As shown in FIG. 11, in an upstream side of the nozzles 70 formed in the lower surface of the recording head 30, there are formed cavities 73 which include piezoelectric elements 72, respectively. Each of the piezoelectric elements 72 is deformed by applying a predetermined voltage thereto so as to reduce volume of a corresponding one of the cavities 73. Thus, the volume of the corresponding cavity 73 is changed, whereby ink in the corresponding cavity 73 is ejected from the corresponding nozzle 70 as a droplet.

The cavities 73 are provided for the respective nozzles 70 and manifolds 74 are formed over a plurality of the cavities 73. The manifolds 74 are provided for the respective inks of four colors, CMYBk. Buffer tanks 75 are provided on an upstream side of the manifolds 74. The buffer tanks 75 are also provided for the respective inks of four colors, CMYBk. Inks which flow through ink tubes 33 are supplied to the buffer tanks 75 from the ink inlets 76, respectively. When the inks are temporarily stored in the respective buffer tanks 75, air bubbles generated in the inks through the ink tubes 33 or the like are separated from the inks, thus preventing the air bubbles from entering the cavities 73 and the manifolds 74. The air bubbles separated from the inks in the respective buffer tanks 75 are removed and sucked from air bubble outlets 77 through the air outlets 71 by a pump 54 of the purging mechanism 44.

For each of the inks of four colors, there is formed an ink path in which each of the inks supplied to the buffer tank 75 through the ink tube 33 flows to the cavities 73 via the manifold 74. Each of the inks which is supplied through the ink path is ejected toward the recording sheet from the nozzles 70 as droplets by deformation of the piezoelectric elements 72.

Passages communicating from the respective air outlets 71 to the respective air bubble outlets 77 are formed within the recording head 30. A negative pressure is produced in the air exhaust cap 53 described below by the pump 54 (as shown in FIGS. 12-15) of the purging mechanism 44 in a state in which each of the air outlets 71 is communicated with the inside of the air exhaust cap 53, whereby air trapped in the buffer tank 75 is removed by sucking.

As shown in FIG. 9, the maintenance unit 80 is disposed outside a recording range in which the recording head 30 (not shown in FIG. 9) reciprocates to perform the recording operation, namely, on one of the opposite sides of the platen 34 where the recording sheet does not pass. The maintenance unit 80 includes the purging mechanism 44 and a waste ink tank. The waste ink tank (not shown in FIG. 9) is disposed below the guide rail 36. The purging mechanism 44 is provided for removing, by sucking, air bubbles and/or foreign substances together with ink from the nozzles 70, etc., of the recording head 30. The purging mechanism 44 includes a cap 46 (nozzle cap) for covering a nozzle surface 48 of the recording head 30. A pump is connected to the cap 46. The pump (not shown in FIG. 9) is disposed below the cap 46. The cap 46 is moved toward and away from the nozzle surface 48 of the recording head 30 by a cap moving mechanism. When the purging mechanism 44 is operated to remove, by sucking, air bubbles, etc., of the recording head 30, the head carriage 31 moves the recording head 30 in a position right above the cap 46. In this state, the cap 46 is moved upward so as to come into fluid-tight contact with the nozzle surface 48 of the recording head 30 such that the nozzles 70 are covered. Ink is sucked from the nozzles 70 of the recording head 30 by a pump connected to the cap 46. The sucked ink is discharged to the waste ink tank 81 (as shown in FIG. 12). The maintenance unit 80 will be explained in greater detail below.

A waste ink tray 45 is disposed outside the recording range by the head carriage 31, namely, at the other side of the purging mechanism 44. The waste ink tray 45 is provided for receiving ink ejected from the recording head 30 in so-called flushing. The flushing is carried out as an operation different from the purging operation, and maintenance such as removal of air bubbles and/or mixed ink from the recording head 30 is performed in the flushing. It is noted that felts are laid in the waste ink tray 45 and ink ejected in the flushing is absorbed and held in the felts.

The ink tubes 33 are formed of synthetic resin and have a flexibility assuring that the ink tubes 33 are flexed according to the reciprocation of the head carriage 31. The ink tubes 33 are provided for the respective ink tanks, and in the present embodiment, four ink tubes 33 are provided respectively corresponding to the inks of four colors. It is noted that the ink tanks are accommodated in the refill unit 119. When the head carriage 31 moves toward a left side one (as seen in FIG. 9) of opposite ends of the range of the reciprocating movement thereof, the ink tubes 33 move in a direction in which the head carriage 31 moves, while being flexed in a manner that reduces a radius of U-shaped curvature thereof. On the other hand, when the head carriage 31 moves toward a right side one (as seen in FIG. 9) of the opposite ends of the range of the reciprocating movement thereof, the ink tubes 33 moves in a direction in which the head carriage 31 moves, while being flexed in a manner that increases a radius of curvature thereof.

As shown in FIG. 9, a flat cable 143 is connected to the head carriage 31. The flat cable 143 is connected to a control circuit board (not shown). Recording signals or the like are transferred to the recording head 30 from the control circuit board via the flat cable 143. The flat cable 143 is a belt-like member including conductors which transmit electric signals and which are covered by a synthetic resin film, such as a polyester film or the like, so as to insulate the conductors from each other. The control circuit board and a circuit board provided on the recording head 30 are electrically connected by the flat cable 143. The flat cable 143 is led out of the head carriage 31 in the head-reciprocating direction, and includes a substantially U-shaped portion that is curved on a horizontal plane The U-shaped portion of the flat cable 143 is not fixed to any other members, and accordingly changes its shape in accordance with the reciprocating movement of the head carriage 31.

As shown in FIG. 8, the sheet-feed roller 47 is provided on the rear side of the recording portion 24. Below the sheet-feed roller 47, there is provided a pinch roller (not shown in FIG. 8) which is held in pressing contact with the sheet-feed roller 47. Each recording sheet is nipped by the sheet-feed roller 47 and the pinch roller so as to be fed onto the platen 34. The sheet-discharge roller 49 is provided on the front side of the recording portion 24. Above the sheet-discharge roller 49, there is provided a pinch rollers (not shown in FIG. 8) which are held in pressing contact with the sheet-discharge roller 49. Each recording sheet on which image has been recorded is nipped by the sheet-discharge roller 49 and the pinch rollers so as to be fed onto the sheet-discharge tray 21. The sheet-feed roller 47 and the sheet-discharge roller 49 are rotated by a drive force transmitted by a motor. The sheet-feed roller 47 and the sheet-discharge roller 49 are intermittently driven, whereby the recording sheet is fed at a predetermined line feed pitch. The respective rotations of the sheet-feed roller 47 and the sheet-discharge roller 49 are synchronized with each other. A photo interrupter (not shown in FIG. 8) detects marks of the encoder disk 69 (not shown in FIG. 8) provided on the sheet-feed roller 47, whereby a rotary encoder detects a rotation of the sheet-feed roller 47, and on the basis of detection signals detected by the rotary encoder, the respective rotations of the sheet-feed roller 47 and the sheet-discharge roller 49 are controlled.

### Maintenance Unit

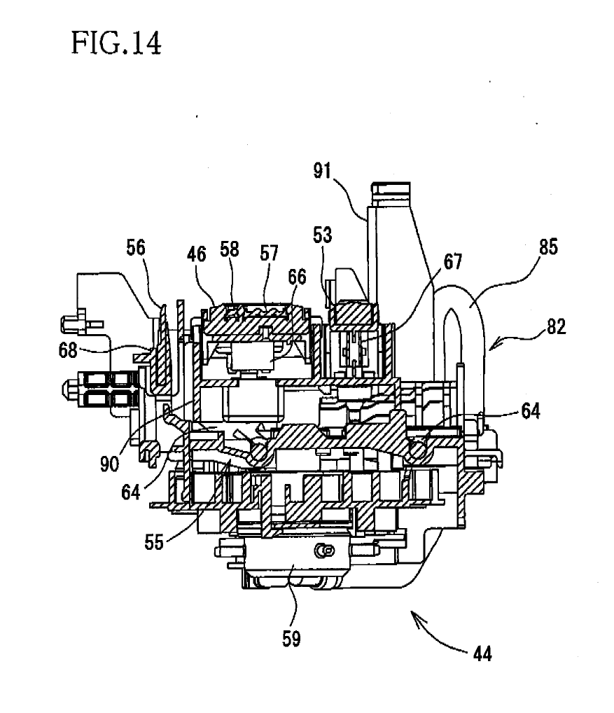

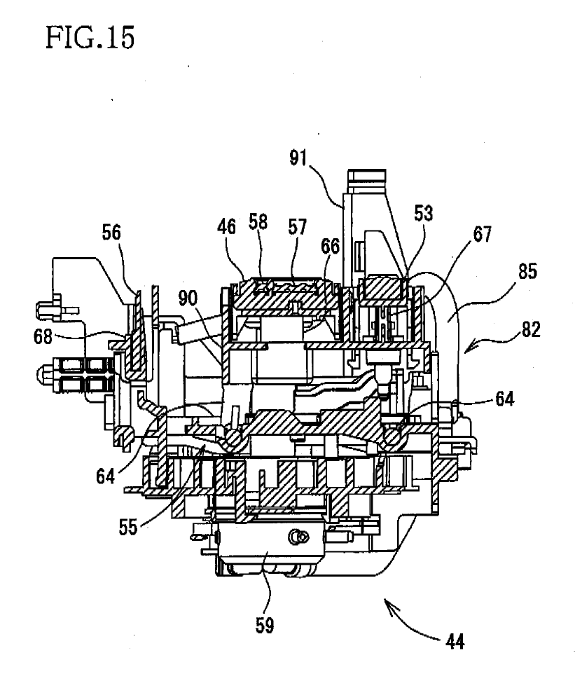

FIG. 12 is a perspective view showing a maintenance unit 80. FIG. 13 is a plan view showing a structure of a purging mechanism 44 included in the maintenance unit 80. FIG. 14 is a cross-sectional view taken along line 14-14 of FIG. 13. FIG. 15 is a cross-sectional view showing a state in which the cap 46 and the air exhaust cap 53 are lifted.

As shown in FIG. 12, the maintenance unit 80 includes the purging mechanism 44, a unit frame 83 by which the purging mechanism 44 is supported, and the waste ink tank 81. The purging mechanism 44 is provided for removing, by sucking, air bubbles and/or foreign substances from the nozzles 70 of the recording head 30. As shown in FIG. 13 and 15, the purging mechanism 44 includes the cap 46 for covering the nozzles 70 of the recording head 30, the air exhaust cap 53 for covering the air outlets 71 of the recording head 30, the pump 54 to be connected to the cap 46 or the air exhaust cap 53 for sucking, a lifting-up mechanism 55 for moving the cap 46 and the air exhaust cap 53 toward and away from the recording head 30, a wiper blade 56 for wiping the nozzle surface 48 of the recording head 30, and a pump tube 82 for connecting the pump 54 to the waste ink tank 81.

The unit frame 83 is formed of metal or resin and positions the cap 46, the air exhaust cap 53, the pump 54, the lifting-up mechanism 55, the wiper blade 56, and the pump tube 82 at their respective predetermined positions. The unit frame 83 has a first tube joint 78 which holds and interconnects two portions of the pump tube 82, and a second tube joint 79 which holds and interconnects two portions of an air communication tube 84 (described below). Each of the tube joints 78, 79 has a cylindrical shape, and is disposed such that each axis of the tube joints 78, 79 is parallel to the vertical direction as shown in FIG. 12. The unit frame 83 is fastened to a frame having the guide rails 35, 36 (shown in FIG. 9) by screws 144. The guide rails 35, 36 are fixed to the platform 111.

As shown in FIGS. 6 and 12, the first tube joint 78 is formed integrally with the unit frame 83. As shown in FIG. 6, the first tube joint 78 is exposed from the platform 111 in a state in which the outer panel 122 is removed, that is, the first tube joint 78 is not hidden behind the platform 111 in a state in which a user opposes to the first tube joint 78, more specifically, the first tube joint 78 is directly and visually identified by a user. As shown in FIGS. 6 and 12, the second tube joint 79 is integrally formed with the unit frame 83, as well as the first tube joint 78. As shown in FIG. 6, the second tube joint 79 is exposed from the platform 111 in the state in which the outer panel 122 is removed. The positional relationship between each of the tube joints 78, 79 and the platform 11 provides advantages that will be described later.

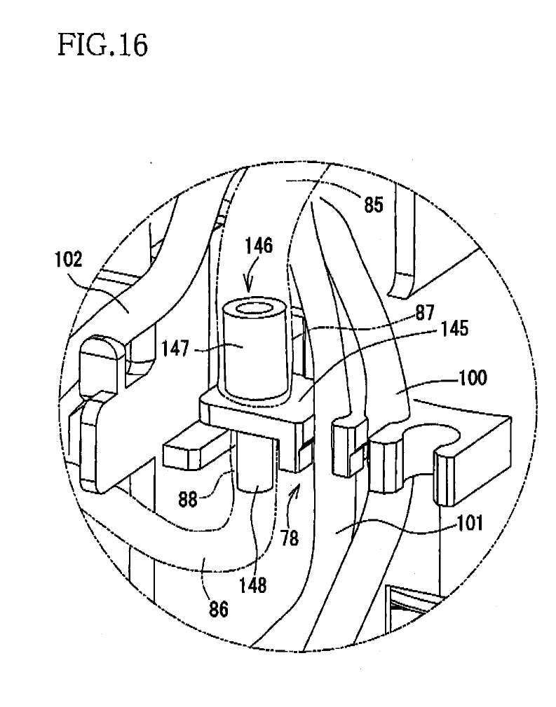

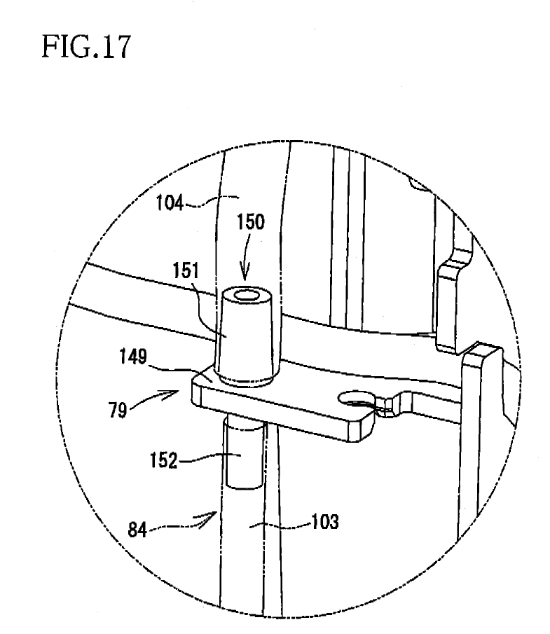

FIG. 16 is an enlarged perspective view of the first tube joint 78 and FIG. 17 is an enlarged perspective view of the second tube joint 79.

As shown in FIG. 16, the first tube joint 78 has a base plate 145 formed integrally with the unit frame 83, and a cylindrical shaft 146 penetrating the base plate 145 in the vertical direction. The cylindrical shaft 146 has a large-diameter portion 147 and a small-diameter portion 148, and the large-diameter portion 147 protrudes upward from the base plate 145, while the small-diameter portion 148 protrudes downward from the base plate 145. An outer diameter of the large-diameter portion 147 corresponds to an inner diameter of a first tube 85 which is one of the two portions of the pump tube 82, while an outer diameter of the small-diameter portion 148 corresponds to an inner diameter of a second tube 86 which is the other of the two portions of the pump tube 82. Therefore, where the first tube 85 is fitted on the large-diameter portion 147, the first tube 85 is elastically expanded in diameter, so that the first tube 85 and the large-diameter portion 147 are air-tightly fitted. Similarly, where the second tube 86 is fitted on the small-diameter portion 148, the second tube 86 is elastically expanded in diameter, so that the second tube 86 and the small-diameter portion 148 are air-tightly fitted. The cylindrical shaft 146 has, in its central portion, a through-hole extending along an axial direction thereof. Therefore, air and ink sent through the first tube 85 is sent to the second tube 86 via the cylindrical shaft 146.

As shown in FIG. 17, the second tube joint 79 has a base plate 149 formed integrally with the unit frame 83, and a cylindrical shaft 150 penetrating the base plate 149 in the vertical direction. The cylindrical shaft 150 has a large-diameter portion 151 and a small-diameter portion 152, and the large-diameter portion 151 protrudes upward from the base plate 149, while the small-diameter portion 152 protrudes downward from the base plate 149. An outer diameter of the small-diameter portion 152 corresponds to an inner diameter of an upstream-side portion of the air communication tube 84, that is, a third tube 103 which is one of the two portions of the air communication tube 84, while an outer diameter of the large-diameter portion 151 corresponds to an inner diameter of a downstream-side portion of the air communication tube 84, that is, a fourth tube 104 which is the other of the two portions of the air communication tube 84 and which has a smaller diameter than the third tube 103. Therefore, where the third tube 103 is fitted on the small-diameter portion 152, the third tube 103 is elastically expanded in diameter, so that the third tube 103 and the small-diameter portion 152 are air-tightly fitted. Similarly, where the fourth tube 104 is fitted on the large-diameter portion 151, the fourth tube 104 is elastically expanded in diameter, so that the fourth tube 104 and the large-diameter portion 151 are air-tightly fitted. The cylindrical shaft 150 has, in its central portion, a through-hole extending along a direction in which an axis of the cylindrical shaft 150 extends. Therefore, air and ink sent through the third tube 103 is sent to the fourth tube 104 via the cylindrical shaft 150.

As shown in FIG. 12, the cap 46 is formed of rubber. The cap 46 comes into fluid-tight contact with the nozzle surface 48 (as shown in FIG. 10) of the recording head 48 so as to define a space between the cap 46 and the nozzle surface 48 and to surround the nozzles 70. An inside of the cap 46 is divided into two spaces corresponding to the color inks CMY and the black ink Bk, respectively, and accordingly two spaces are defined between the cap 46 and the nozzle surface 48 for the color inks and the black ink, respectively. It is noted that the space formed between the cap 46 and the nozzle surface 48 can be considered to be divided into two spaces or to have two parts. Supporting members 57, 58 are fitted in the two spaces, respectively, thereby preventing a lip portion of the cap 46 from buckling. In bottom portions of the respective spaces of the cap 46, there are formed air intakes (not shown) which communicate with the pump 54 via a port changing mechanism 59 (communication-changing mechanism). The port changing mechanism 59 has a port changing member (described below) by which a selected one of port connections is established. The port changing mechanism 59 will be explained in greater detail below.

The air exhaust cap 53 as well as the cap 46 is formed of rubber. The air exhaust cap 53 comes into fluid-tight contact with the nozzle surface 48 (as shown in FIG. 10) so as to surround the air outlets 71 of the recording head 30. Four push rods 50 respectively corresponding to the air outlets 71 for the inks of the respective colors CMYBk are provided in the air exhaust caps 53 so as to extend upward in the vertical direction. The push rods 50 are arranged to advance upward and to retract downward. When each of the push rods 50 advances upward to be inserted to a corresponding one of the air outlets 71, whereby the check valve of the corresponding air outlet 71 is opened. In the present embodiment, three push rods 50 corresponding to the color inks CMY are arranged to advance and retract independently of one push rod corresponding to the black ink Bk. Therefore, when the push rod or rods 50 corresponding to the black ink and/or color inks advance, the push rod of rods 50 are inserted to the corresponding air outlet or outlets 71. In a bottom portion of the air exhaust cap 53, there is formed an air intake 52 which communicates with the pump 54 via the port changing mechanism 59.

The pump 54 is a tube pump of rotary type. Although not shown in FIG. 12, in the present embodiment, the pump 54 includes a casing having an inner surface and a roller to be rolled along the inner surface. The pump tube 82 includes the first tube 85 passing through an inside of the pump 54 and the second tube 86 connected to the first tube 85. The first tube 85 is disposed between the roller and the inner surface of the casing. When the roller is driven, the first tube 85 is squeezed and ink in the first tube 85 is moved from the upstream portion of the first tube 85 to the downstream portion of the first tube 85. The first tube 85 is squeezed in the pump 54 and thereby receives a large amount of external force. Therefore, the first tube 85 has a required wear resistance. In the present embodiment, the first tube 85 is a silicon rubber tube, It is noted that the first tube 85 is not limited to the silicon rubber tube, and any tubes formed of other material may be employed as long as the tubes have the required wear resistance. A first end 87 which is one of opposite ends of the first tube 85 is fitted on the large-diameter portion 147 of the first tube joint 78. On the other hand, the second tube 86 does not receive a large amount of external force from the pump 54, etc., in contrast to the first tube 85, and therefore the wear resistance and the durability are not particularly required. Accordingly, in the present embodiment, the second tube 86 is a polyvinyl chloride tube. It is noted that the second tube 86 is not limited to the polyvinyl chloride tube, and other low-cost tubes having a general versatility may be employed. A first end 88 which is one of opposite ends of the second tube 86 is fitted on the small-diameter portion 148 of the first tube joint 78. It is also noted that a large degree of negative pressure is efficiently produced in the first tube 85 when the pump 54 is driven, because the first tube 85 has a larger diameter than the second tube 86.

As shown in FIG. 14, the lifting-up mechanism 55 has a pair of right and left link members 64 which have a same length. The link members 64, 64 are pivoted, whereby a holder 90 is moved in parallel and displaced between a stand-by position and a close-contact position. In FIG. 14, the holder 90 is in the stand-by position, while in FIG. 15, the holder 90 is in the close-contact position. The holder 90 is moved in parallel on an are-shaped track by the link members 64 in a right and left direction as seen in FIG. 14 (the head-reciprocating direction). The holder 90 is kept elastically biased by a spring (not shown) so as to be displaced toward the stand-by position. The holder 90 has an abutment lever 91 protruding upward in the vertical direction. The head carriage 31 presses the abutment lever 91 in a right direction as seen in FIGS. 14 and 15, whereby the holder 90 is moved to the close-contact position against an elastic force of the spring.

The cap 46 and the air exhaust cap 53 are mounted on the holder 90. The cap 46 and the air exhaust cap 53 receive elastic forces generated by coil springs 66, 67, respectively, so as to be biased upward. With movement of the holder 90 to the close-contact position, the cap 46 comes into fluid-tight contact with a portion of the nozzle surface 48 that defines a periphery surrounding the four rows of the nozzles 70, while the exhaust cap 53 comes into fluid-tight contact with a portion of the nozzle surface 48 that defines a periphery surrounding the row of the air outlets 71. When the holder 90 is displaced to the close-contact position, the coil springs 66, 67 are compressed, whereby the cap 46 and the air exhaust cap 53 are elastically biased by the coil spring 66, 67, so as to maintain their respective positions for air-tightly closing the nozzles 70 and the air outlets 71.

The wiper blade 56 is fitted in a wiper holder 68 and arranged to advance from and retract into the wiper holder 68. The wiper blade 56 is formed of rubber. The length of the wiper blade 56 (as measured in a direction perpendicular to the sheet surface of each of FIGS. 14 and 15) corresponds to the length of the nozzle surface 48 of the recording head 30. When the wiper blade 56 is advanced from the wiper holder 68, the same 56 is brought into contact with the nozzle surface 48. When the recording head 30 slides together with the head carriage 31 in a state in which the wiper blade 56 is held in contact with a lower surface of the recording head 30, the wiper blade 56 wipes ink adhering to the nozzle surface 48. The advancing and retracting of the wiper blade 56 are controlled by a cum mechanism (not shown), and the wiper blade 56 are advanced when the recording head 30 slides toward an image recording area after a purging operation is terminated.

When the purging operation is performed, that is, when air bubbles and the like are sucked and removed from the nozzles 70 of the recording head 30, the head carriage 81 is moved and the recording head 30 is positioned above the cap 46 and the air exhaust cap 53. When the abutment lever 91 is pressed by the head carriage 31, the cap 46 and the air exhaust cap 53 are moved to the close-contact position by the lifting-up mechanism 55. As a result, while spaces are formed between the nozzle surface 48 and the cap 46, the cap 46 comes into fluid-tight contact with the nozzle surface 48 so as to seal the portion of the nozzle surface 48 that defines the periphery surrounding the four rows of the nozzles 70. In addition, the air exhaust cap 53 comes into fluid-tight contact so as to seal the portion of the nozzle surface 48 that defines the periphery surrounding the row of the air outlets 71.

The port changing mechanism 59 selectively connects and disconnects each of air intake passages connected to air intakes of the cap 46 and an air intake passage connected to the air intake 52 (as shown in FIG. 13) of the air exhaust cap 53, to and from the pump 54. A communicating state of each of the cap 46 and the exhaust cap 53, and the pump 54 is changed between the connecting state and the disconnecting state by the port changing mechanism 59. For instance, when ink in the nozzles 70 is sucked, the communicating state of the cap 46 and the pump 54 is changed to the connecting state, and the communicating state of the air exhaust cap 53 and the pump 54 is changed to the disconnecting state. In this state, the pump 54 is driven to perform the sucking operation, whereby a negative pressure is produced within the cap 46 and the ink is sucked from the nozzles 70. Air bubbles and/or foreign substances in the nozzles 70 are sucked and removed together with the ink. After this operation, the head carriage 31 slides to move away from the abutment lever 91 and the cap 46 and the air exhaust cap 53 move back to the stand-by position by the lifting-up mechanism 55. On the other hand, when air is sucked from the air outlets 71, the communicating state of the air exhaust cap 53 and the pump 54 is changed to the connecting state and the communicating state of the cap 46 and the pump 54 is changed to the disconnecting state. Then, as described above, the push rods 50 open the check valves of the air outlets 71, and in this state, the pump 54 is driven. As a result, a negative pressure is produced within the air exhaust cap 46 and air is sucked from the air outlets 71. After this operation, the head carriage 31 slides to move away from the abutment lever 91 and the cap 46 and the air exhaust cap 53 move back to the stand-by position by the lifting-up mechanism 55. Further, the wiper blade 56 is brought into contact with the nozzle surface 48 of the recording head 30 mounted on the head carriage 31 which is sliding, whereby ink adhering to the nozzle surface 48 is wiped.

When the pump 54 is driven, the first tube 85 is squeezed, whereby the sucking operation is performed. More specifically, as shown in FIG. 13, a pump gear is driven through a bevel gear 89. Although a detail of the pump gear and a drive-force transmission mechanism to the pump gear is not shown in FIG. 13, the pump gear is rotated on the basis of a rotation transmitted to the bevel gear 89, and rollers of the pump 54 squeeze the first tube 85, whereby the sucking operation is performed. As shown in FIG. 12, the pump 54 is driven, whereby the ink and air are sent to the second tube 86 through the first tube 85 via the first tube joint 78. The second tube 86 is connected to a side face 92 of the waste ink tank 81, and accordingly the ink and air are absorbed in the waste ink tank 81. A constitution of the waste ink tank 81 will be explained in greater detail below.

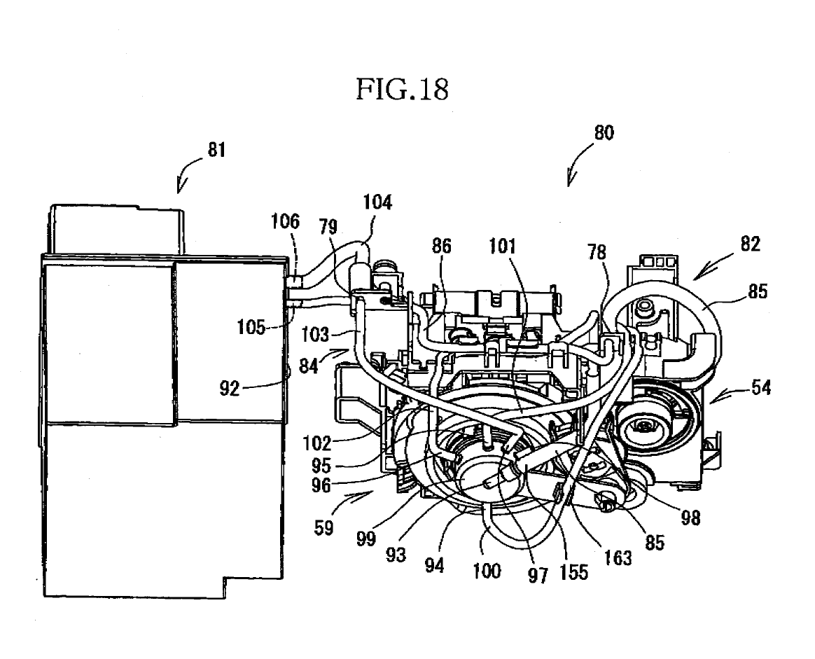

FIG. 18 is a perspective view of the maintenance unit 80 showing an external view of the port changing mechanism 59. It is noted that because the constitution of the port changing mechanism 59 is known, hereinafter, an operation of the port changing mechanism 59 is mainly explained.

The port changing mechanism 59 includes a cover 99 formed with six ports 93-98 and a port changing member having a disc like shape (not shown) disposed within the cover 99. The port changing member is rotated by a drive source which drives the pump gear, and connects one or ones of the ports 93-98 to another of the ports 93-98 as described below. The cover 99 is formed of resin and has a cylindrical shape having a bottom. An air intake port 93 is formed at a central portion of a bottom face of the cover 99. A second end 155 which is the other of above described opposite ends of the first tube 85 constituting the pump tube 82 is connected to the air intake port 93. As described above, the first tube 85 passes through the inside of the pump 54 and is connected to the first tube joint 78. More specifically, as shown in FIG. 12, the first tube 85 is arranged between the rollers of the pump 54 and the casing, and the first end 87 of the first tube 85 is fitted on the large-diameter portion 147 of the first tube joint 78.

As shown in FIGS. 16 and 18, the first end 88 of the second tube 86 is connected to the small-diameter portion 148 of the first tube joint 78, whereby the first tube 85 and the second tube 86 are interconnected. In this case, the word “interconnected” means that the first tube 85 and the second tube 86 are communicated with each other via the first tube joint 78, and ink and air sent through the first tube 85 are sent to the second tube 86 via the first tube joint 78. Therefore, there is no need that the first tube 85 and the second tube 86 are directly contacted with each other. As shown in FIG. 12, the second tube 86 extends toward the waste ink tank 81 while being nipped and held by clips 157-160, and further extends toward the waste ink tank 81 while being supported by a bracket 161 provided on the base plate 149. A second end 162 which is the other of above-described opposite ends of the second tube 86 is connected to a fourth tube joint 105 of the waste ink tank 81.

As shown in FIG. 18, the other five ports 94-98 are circumferentially arranged on a periphery wall of the cover 99 at a predetermined distance between each adjacent two of the ports 94-98. The first port 94 is an air exhaust port. In the present specification, the port 94 is referred to as an air exhaust port 94. The air exhaust port 94 is communicated with the air exhaust cap 53 (as shown in FIG. 13). A tube 100 interconnects the air exhaust port 94 and the air exhaust cap 53. The tube 100 is curved upward from the cover 99 while being nipped and held by a bracket 163. Then, the tube 100 is nipped and held by the base plate 145 of the first tube joint 78 (as shown in FIG. 16) and connected to the air exhaust cap 53 as shown in FIG. 13.

As shown in FIG. 18, the second port 95 is communicated with the cap 46 (as shown in FIG. 13). More specifically, the port 95 is communicated with a space provided for black ink, which space is defined between the cap 46 and the nozzle surface 48. In the present specification, the port 95 is referred to as a Bk port 95. The tube 101 interconnects the Bk port 95 and the cap 46 The tube 101 is curved upward from the cover 99, nipped and held by the base plate 145 of the first tube joint 78 (as shown in FIG. 16), and connected to the cap 46 as shown in FIG. 13.

As shown in FIG. 18, the third port 96 is communicated with the cap 46 (as shown in FIG. 13). More specifically, the port 96 is communicated with a space provided for color inks, which space is defined between the cap 46 and the nozzle surface 48. In the present specification, the port 96 is referred to as a Co port 96. The tube 102 interconnects the Co port 95 and the cap 46. The tube 102 is curved upward from the cover 99, extends toward the pump 54 while being nipped and held by the clips 157-160 (as shown in FIG. 12), further extends upward, and then connected to the cap 46 as shown in FIG. 13. It is noted that a polyvinyl chloride tube or other low-cost tubes having a general versatility may be employed for the tubes 100-102.

The fourth port 97 and the fifth port 98 are communicated with the atmosphere. The ports 97, 98 are referred to as an atmospheric port 97 and an atmospheric port 98, respectively. The air communication tube 84 is connected to the atmospheric port 97. The air communication tube 84 includes the third tube 103 one of opposite ends of which is connected to the atmospheric port 97, and the fourth tube 104 connected to the third tube 103. The other of the opposite ends of the third tube 103 is connected to the second tube joint 79. One of opposite ends of the fourth tube 104 is connected to the second tube joint 79, while the other of the opposite ends of the fourth tube 104 is connected to a third tube joint 106 of the waste ink tank 81.

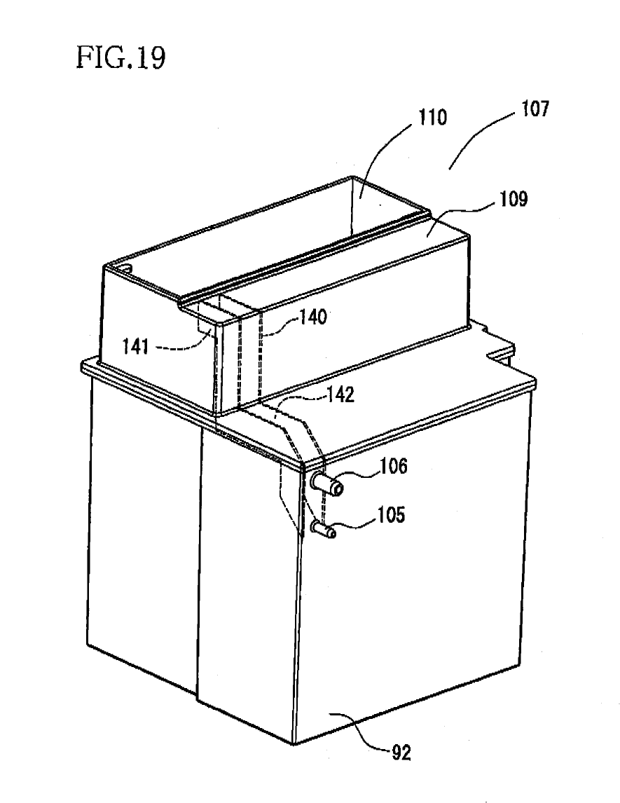

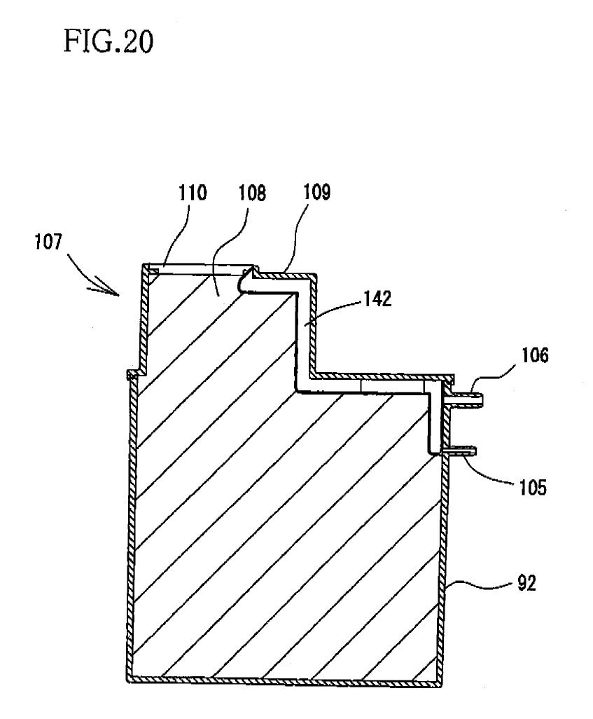

As shown in FIG. 12, the waste ink tank 81 includes a casing 107 and an ink absorbing element 108 accommodated in the casing 107. FIG. 19 is a perspective view of the waste ink tank 81, FIG. 20 is a cross-sectional view of the waste ink tank 81.

The casing 107 has a three-dimensional shape in which two rectangular parallelepipeds are superposed on each other. The reason why the casing 107 is formed in odd-form is that the MFD 1 is recently made compact in size at a reduced cost, and the printer unit 2 and other functional components are given a high priority in its design, resulting in a waste ink tank often being configured to correspond to a remaining space in the platform 111. Therefore, the configuration and position of the waste ink tank 81 varies depending on a spec of the MFD 1.

The casing 107 is integrally formed of resin. An opening 110 is formed in an upper face 109 of the casing 107, and a part of the ink absorbing element 108 is exposed from the opening 110. In FIG. 19, the ink absorbing element 108 is not shown. The fourth tube joint 105 and the third tube joint 106 are provided on a side face of the casing 107 (that is, the side face 92). The third tube joint 106 is disposed in the vicinity of an upper end of the side face 92. The third tube joint 106 is a cylindrical member and penetrates a wall which defines the side face 92. As a result, an interior and an exterior of the casing 107 are communicated with each other and, as described above, the other of the opposite ends of the fourth tube 104 is connected to the third tube joint 106, whereby air, ink, and the like guided by the air communication tube 84 are flowed into the casing 107 and absorbed in the ink absorbing element 108.

The fourth tube joint 105 is disposed immediately below the third tube joint 106. The fourth tube joint 105 is a cylindrical member as well as the third tube joint 106 and penetrates the wall which defines the side face 92. As a result, the interior and the exterior of the casing 107 are communicated with each other and, as described above, the second end 162 of the second tube 86 is connected to the fourth tube joint 105, whereby ink and the like guided by the pump tube 82 are flowed into the casing 107 and absorbed in the ink absorbing element 108.

The fourth tube joint 105 and the third tube joint 106 are disposed at their respective positions described above, and thereby, as shown in FIG. 6, exposed from the platform 111. That is, the fourth tube joint 105 and the third tube joint 106 are exposed from the platform 111 in the state in which the outer panel 122 is removed. Advantages in which the fourth tube joint 105 and the third tube joint 106 are disposed at the positions will be described below.

As shown in FIGS. 19 and 20, a pair of ribs 140, 141 are provided in the casing 107. The ribs 140, 141 are disposed so as to be opposed to each other at a predetermined distance therebetween. The ink absorbing element 108 is deformed by the ribs 140, 141 that are pressed against the element 108, whereby a space 142 is formed. The ink absorbing element 108 does not have any portion disposed in the space 142, and the fourth tube joint 105 and the third tube joint 106 are communicated with the space 142. That is, the fourth tube joint 105 and the third tube joint 106 communicate the space 142 with the exterior of the casing 107, and accordingly an amount of flow resistance of air passing through the fourth tube joint 105 and the third tube joint 106 is extremely small.

The ink absorbing element 108 is constituted by a large number of cotton seats stacked on each other, for instance. An outer shape of the ink absorbing element 108 corresponds to an inner space of the casing 107, so that the ink absorbing element 108 is packed in the casing 107 with substantially no space between the element 108 and the casing 107. Ink and the like sent into the casing 107 through the fourth tube joint 105 or the third tube joint 106 are certainly absorbed in the ink absorbing element 108.

The ink and the like sucked from the recording head 30 by the maintenance unit 80 are sent to the waste ink tank 81 as follows.

When air bubbles trapped in the buffer tank 75 (as shown in FIG. 11) are to be discharged, the head carriage 31 is positioned right above the maintenance unit 80, that is, right above the cap 46 and the air exhaust cap 53. In this state, the air exhaust cap 53 comes into fluid-tight contact with the nozzle surface 48 of the recording head 30, whereby a space is defined therebetween. The port changing member is driven and the space defined between the air exhaust cap 53 and the nozzle surface 48 is communicated with the pump 54. That is, the space is communicated with the air intake port 93 (as shown in FIG. 18). The push rod 50 provided for the black ink (as shown in FIG. 13) is pushed up and the air outlet 71 is communicated with the interior of the air exhaust cap 53. And then, the pump 54 is driven to suck air bubbles trapped in the buffer tank 75 provided for the black ink. The air bubbles sucked by the pump 54 are released into the atmosphere via the pump tube 82. The pump tube 82 is connected to the waste ink tank 81, whereby the air bubbles sucked by the pump 54, together with ink mist, and the like included in the sucked air bubbles, are absorbed in the waste ink tank 81. When an air discharging operation for the black ink is terminated, the push rod 50 is moved to close the air outlet 71.

The push rods 50 provided for the color inks (as shown in FIG. 13) are pushed up and the air outlets 71 are communicated with the interior of the air exhaust cap 53. And then, the pump 54 is driven to suck air bubbles trapped in the buffer tanks 75 provided for the color inks. The air bubbles sucked by the pump 54 are released into the atmosphere via the pump tube 82. The pump tube 82 is connected to the waste ink tank 81, whereby the air bubbles sucked by the pump 54, together with ink mist, and the like included in the sucked air bubbles, are absorbed in the waste ink tank 81. When the air discharging operation for the color inks is terminated, the push rods 50 are moved to close the air outlets 71.

When air bubbles and foreign substances are to be discharged from the recording head 30, the head carriage 31 is positioned right above the cap 46 and the air exhaust cap 53, and the atmospheric port 97 is connected to the Bk port 95 and the Co port 96, the cap 46 comes into fluid-tight contact with the nozzle surface 48 of the recording head 30, whereby spaces are defined between the cap 46 and the nozzle surface 48. When the port changing member is driven and the atmospheric port 97 is disconnected from the Bk port 95 and the Co port 96, the space defined between the cap 46 and the nozzle surface 48 is disconnected from the atmosphere and is not communicated with the pump 54. In this state, the pump 54 is driven and a negative pressure is produced and charged in the pump tube 82, that is, an interior of the pump tube 82 is depressurized. In the case of suction of the black ink, the port changing member is driven, whereby a part of the space formed between the cap 46 and the nozzle surface 48, which part of the space corresponds to the black ink is connected to the pump 54. That is, the Bk port 95 is connected to the air intake port 93, and the black ink is sucked in a burst toward the pump 54 through the nozzles 70. The sucked ink is absorbed in the waste ink tank 81 via the pump tube 82.

In the case of suction of color inks, the port changing member is driven, whereby a part of the space defined between the cap 46 and the nozzle surface 48, which part of the space corresponds to the color inks is connected to the pump 54. That is, the Co port 96 is connected to the air intake port 93, and the color inks are sucked in a burst toward the pump 54 through the nozzles 70. The sucked ink is absorbed in the waste ink tank 81 via the pump tube 82. After the sucking operation performed for the black ink and the color inks is terminated, the atmospheric port 97 is connected to the Bk port 95 and the Co port 96, and the space defined between the cap 46 and the nozzle surface 48 is communicated with the atmosphere, and then the cap 46 is removed.

In an ink-jet recording apparatus, it is generally expected that air bubbles and/or foreign substances are trapped in the nozzles 70, but ink is sucked and air bubbles are discharged from the recording head 30 as described above, thereby resolving clogging or the like of the nozzles 70. It is noted that, in the present embodiment, a negative pressure is preliminarily produced and charged in the pump tube 82 and ink is sucked in a burst, but it is to be understood that the charging of the negative pressure may be omitted.

### Advantages of the MFD of the Present Embodiment

In the present embodiment, ink sucked by the pump 54 is sent to the waste ink tank 81 via the pump tube 82. The pump tube 82 is divided into two tubes which are interconnected by the first tube joint 78 provided on the unit frame 83 of the maintenance unit 80. As shown in FIGS. 6 and 12, the first tube joint 78 is exposed from the platform 111 in a state in which the outer panel 122 is removed. Therefore, the following advantages are obtained.

In an assembling process of the MFD 1, a work for arrangement of the tubes can be easily performed owing to the arrangement in which the pump tube 82 is divided into two tubes and also the arrangement which permits an assembling worker to interconnect the two tubes via the first tube joint 78 while visually checking the first tube 85 and the second tube 86. Therefore, an assembling work of the maintenance unit 80 and consequently an assembling of the MFD 1 are facilitated.

In an ink-jet recording apparatus, a pump tube is sometimes removed in a maintenance. In general, when the pump tube is fitted on a tube joint, an end portion of the pump tube is plastically deformed, so that where the pump tube is removed from the tube joint, the end portion of the pump tube is kept plastically expanded in diameter. Accordingly, after the maintenance, fitting the expanded pump tube on the tube joint may cause a risk of leakage of ink, and usually to avoid this risk, the expanded portion is cut from the pump tube. Therefore, where the pump tube is not divided, the length of the pump tube is determined, in advance, to have an extra length to be removed. However, there is an upper limit of the length of the pump tube and the length cannot be determined to have a large amount of extra length because the MFD is requested to be designed compactly. The result is that a replacement of the entire pump tube is needed in the second maintenance. Further, when the pump is operated, the pump tube is squeezed and receives a large amount of external force. Therefore, the pump tube needs to be formed of a material which has a high wear resistance, and in general, such material is expensive. Accordingly, where the pump tube is not divided, the entire pump tube is constituted by an expensive material, whereby the pump tube becomes highly expensive.

In the present embodiment, the pump 54 is a tube pump. Accordingly, when the pump 54 is operated, the pump tube 82 is squeezed and receives a large amount of external force. Therefore, the pump tube 82 is divided into two tubes, that is, the pump tube 82 includes the first tube 86 which has a high wear resistance, such as a silicone rubber tube, and the second tube 86 which is a relatively low-cost tube and has a general versatility, such as a polyvinyl chloride tube. In a maintenance of the maintenance unit 80, only the second tube 86 may be replaced. The second tube 86 is a relatively low-cost, so that a total cost of the maintenance does not rise considerably even if the second tube 86 is replaced in every maintenance. In addition, as described above, in the state in which the outer panel 122 is removed, the first tube joint 78 is exposed, whereby a maintenance worker can easily replace the second tube 86. As a result, the replacement of the second tube 86 or other maintenances are speedily and inexpensively performed, without necessity of removal of the maintenance unit 80 from the platform 111. In the maintenance of the maintenance unit 80, a worker can replace the second tube 86 without having to carry out a work for disassembling the maintenance unit 80.

Next, an air communication tube will be explained where the air communication tube is removed from a tube joint, the end portion of the air communication tube is kept plastically expanded in diameter, and generally the expanded portion is cut from the air communication tube. Therefore, if the air communication tube is not divided, the length of the air communication tube is determined, in advance, to have an extra length to be removed. However, there is an upper limit of the length of the air communication tube and the length cannot be determined to have a large amount of extra length because the MFD is requested to be designed compactly. The result is that a replacement of the entire air communication tube is needed in the second maintenance.

In the present embodiment, the air communication tube 84 is divided into two tubes which are interconnected by the second tube joint 79 provided on the unit frame 83 of the maintenance unit 80. The fourth tube 104 having a larger diameter than the third tube 103 is employed in a downstream portion of the air communication tube 84, that is, in a portion of the air communication tube 84 interconnecting the second tube joint 79 and the waste ink tank 81. If an inner diameter of the air communication tube 84 is smaller than a certain extent, ink mixed into air in the air communication tube 84 may cause a risk that the air communication tube 84 is choked due to surface tension acting between the ink and the air communication tube 84, and it becomes hard for the air to release into the atmosphere. However, like the present embodiment, the fourth tube 104 having a large diameter is employed in the downstream portion of the air communication tube 84, whereby there is less risk of the air communication tube 84 choked by the ink.

Further, because the air communication tube 84 is divided, only a portion in which the air communication tube 84 is deteriorated is replaced in a maintenance, so that a total cost of the maintenance does not rise considerably. In addition, as described above, the second tube joint 79 is exposed in the state in which the outer panel 122 is removed, whereby a replacement of the air communication tube 84 becomes easier for a worker irrespective of whether the worker replace the third tube 103 or the fourth tube 104. As a result, the replacement of the air communication tube 84 or other maintenances are speedily and inexpensively performed, without the maintenance unit 80 removed from the platform 111. It is noted that, as described above, the air communication tube 84 is more preferred with large inner diameter to avoid the choking of the air communication tube 84, but if the entire air communication tube 84 has a large diameter, the air communication tube 84 becomes expensive. However, in the present embodiment, the fourth tube 104 having a large diameter is employed for only a part of the air communication tube 84, thereby enabling the air communication tube 84 to be inexpensive.

In a manufacturing process of an ink-jet recording apparatus, a purging operation is preliminarily performed before shipment. In this case, if the purging operation is performed in a state in which the maintenance unit is fully assembled, the ink absorbing element 108 of the waste ink tank needlessly gets dirty. To prevent this, in the present embodiment, the purging operation before shipment is performed in a state in which the fourth tube 104 of the air communication tube 84 is removed from the third tube joint 106, and the second tube 86 of the pump tube 82 is removed from the fourth tube joint 105. It is noted that the fourth tube 104 is removed from the third tube joint 106, and the second tube 86 is removed from the fourth tube joint 105 in a maintenance to avoid a risk that the ink absorbing element 108 gets dirty. After the purging operation before shipment or in a maintenance is terminated, the fourth tube 104 is fitted on the third tube joint 106 and the second tube 86 is fitted on the fourth tube joint 105. In these cases, the tube joints 105, 106 are exposed in the state in which the outer panel 122 is removed, thereby facilitating a fitting operation in which the second tube 86 and the fourth tube 104 are fitted on the fourth tube joint 105 and the third tube joint 106, respectively.

Furthermore, the third tube joint 106 is provided in the vicinity of the upper end of the side face 92, so that a worker can fit or remove the fourth tube 104 on or from the third tube joint 106 with greater ease, by only removing the outer panel 122. In addition, the fourth tube joint 105 is also provided on the side face 92 of the waste ink tank 81, so that a worker can fit or remove the second tube 86 of the pump tube 82 on or from the fourth tube joint 105 with greater ease. Described in more detail, as described above, a request that the ink-jet recording apparatus is designed compactly has been increased recently, so that a waste ink tank is often formed in odd-form. On the other hand, because an air communication tube and a pump tube are provided for guiding the air or ink into the waste ink tank, it is preferable for the air communication tube and the pump tube to be connected to the upper face (as shown in FIG. 19) of the waste ink tank. However, the waste ink tank may have any one of various forms or the like, so that it often becomes hard to connect the pump tube and the air communication tube to the upper face of the waste ink tank. However, in the present embodiment, the pump tube 82 and the air communication tube 84 are connected to the side face 93 of the waste ink tank 81 via the tube joints 105, 106, respectively. As a result, even if the waste ink tank 81 is distant from the pump 54 or disposed at a position in which the waste ink tank 81 is skew with respect to the pump 54, the pump tube 82 and the air communication tube 84 can be easily connected to the waste ink tank 81. In addition, where the tube joints 105, 106 are provided on the side face 92, a height of the waste ink tank 81 and, consequently, a height dimension of the maintenance unit 80 can be reduced, thereby enabling the MFD 1 to be further thinner.

In the present embodiment, the space defined between the cap 46 and the nozzle surface 48 is communicated with the atmosphere. In addition, because the air communication tube 84 is provided, an air in the space is released into the atmosphere via the waste ink tank 81. Therefore, even if ink is mixed with the air, the ink is guided to the waste ink tank 81 via the air communication tube 84.

Further, there is a possibility that an internal pressure is fluctuated in the space defined between the cap 46 and the nozzle surface 48. The internal pressure of the space is fluctuated as the cap 46 is elastically deformed when the cap 46 is fitted or removed on or from the nozzle surface 48 in the purging operation, for instance. As a result, meniscuses of ink formed in the nozzles 70 may be broken, thereby causing a problem such as an ink ejection failure and an ink leakage However, in the present embodiment, the fluctuation of the internal pressure can be prevented where the atmospheric port 97 is connected to the Bk port 95 and the Co port 96, and the space defined between the cap 46 and the nozzle surface 48 is communicated with the atmosphere, as described above.

Furthermore, in the present embodiment, when the recording head 30 does not perform the recording operation, the recording head 30 moves to a position above the cap 46 and then the nozzle surface 48 is fitted on the cap 46. In this state, as time elapses, the space may be expanded with rise of a temperature in the space, so that the internal pressure in the space may be fluctuated, thereby causing a risk that meniscuses of ink formed in the nozzles 70 may be broken. However, the fluctuation of the internal pressure can be prevented where the atmospheric port 97 is connected to the Bk port 95 and the Co port 96, and the space formed between the cap 46 and the nozzle surface 48 is communicated with the atmosphere.

In the present embodiment, as shown in FIGS. 6 and 12, the tube joints 78, 79 are disposed so as to be exposed at a back corner portions of the platform 111 as seen from the front of the MFD 1, but positions of the tube joints 78, 79 are not limited to the back corner portions. In short, the tube joints 78, 79 may be disposed at any positions in which the tube joints 78, 79 are exposed from the platform 111 in the state in which the outer panel 122 is removed, such that a worker can handle the pump tube 82 and the air communication tube 84.

In the present embodiment, the waste ink tank 81 is adjacent to the maintenance unit 80, but may be disposed at other positions. In this case, the tube joints 105, 106 may be disposed at any positions in which a worker can easily handle the pump tube 82 and the air communication tube 84 in the state in which the outer panel 122 is removed.

Further, the MFD 1 of the present embodiment includes the color inks and the black ink, but may include only the black ink, with the color inks omitted. In this case, a portion of the recording head 30 corresponding to the color inks is omitted, and a portion of the cap 46, a portion of the air exhaust cap 53 each corresponding to the color inks, and the tube 102 are also omitted.

In addition, in the present embodiment, the air outlets 71 are formed in the recording head 30 and the air exhaust cap 53 is provided for discharging air bubbles, but the air exhaust cap 58 may be omitted. In this case, the tube 100 may also be omitted.

What is claimed is:

1. An ink-jet recording apparatus, comprising:
a recording device which includes a nozzle surface and which records an image on a recording medium by ejecting droplets of ink from nozzles open in the nozzle surface while reciprocating in a predetermined direction;
a maintenance unit which includes a nozzle cap coming into fluid-tight contact with the nozzle surface for covering the nozzles, a pump to be connected to the nozzle cap for sucking the ink from the nozzles, and a waste ink tank to which the ink sucked by the pump is discharged;
a platform which supports the recording device and the maintenance unit at respective predetermined positions thereof; and
an outer cover which is fitted on the platform,
wherein the maintenance unit further includes: a frame which holds the pump; a pump tube which is provided for the pump and connected to the waste ink tank and which is divided into a first tube and a second tube; and a first tube joint which is provided on the frame, which interconnects the first tube and the second tube, and which is disposed at a position in which the first tube joint is exposed from the platform in a state in which the outer cover is removed.

2. The ink-jet recording apparatus according to claim 1, wherein the pump is a tube pump and wherein the first tube is configured to pass through an inside of the pump, while the second tube is connected to the waste ink tank.

3. The ink-jet recording apparatus according to claim 2, wherein the second tube is formed of a material which has less wear resistance than a material forming the first tube.

4. The ink-jet recording apparatus according to claim 2, wherein the first tube has a larger diameter than the second tube.

5. The ink-jet recording apparatus according to claim 1, wherein the maintenance unit further includes:
a communication-changing mechanism for communicating a space with atmosphere, the space defined by the nozzle surface and the nozzle cap;
an air communication tube which is connected to a port of the communication-changing mechanism so as to communicate the port with the waste ink tank and which is divided into a third tube and a fourth tube; and
a second tube joint which is provided on the frame, which interconnects the third tube and the fourth tube, and which is disposed at a position in which the second tube joint is exposed from the platform in the state in which the outer cover is removed.

6. The ink-jet recording apparatus according to claim 5, wherein the third tube is connected to the communication-changing mechanism and wherein the fourth tube is connected to the waste ink tank.

7. The ink-jet recording apparatus according to claim 6, wherein the fourth tube has a larger diameter than the third tube.

8. The ink-jet recording apparatus according to claim 5, wherein the waste ink tank includes a third tube joint to which the air communication tube is connected.

9. The ink-jet recording apparatus according to claim 8, wherein the third tube joint is disposed at a position in which the third tube joint is exposed from the platform in the state in which the outer cover is removed.

10. The ink-jet recording apparatus according to claim 8, wherein the waste ink tank further includes a casing and an ink absorbing element which is accommodated in the casing and wherein the third tube joint is provided on an outer surface of the casing so as to communicate an interior of the casing with an exterior of the casing.

11. The ink-jet recording apparatus according to claim 1, wherein the waste ink tank includes a fourth tube joint to which the pump tube is connected.

12. The inkjet recording apparatus according to claim 11, wherein the fourth tube joint is disposed at a position in which the fourth tube joint is exposed from the platform in the state in which the outer cover is removed.

13. The ink-jet recording apparatus according to claim 11, wherein the waste ink tank further includes a casing and an ink absorbing element which is accommodated in the casing and wherein the fourth tube joint is provided on an outer surface of the casing so as to communicate an interior of the casing with an exterior of the casing.
